(19) United States
(12) Patent Application Publication
(10) Pub. No.: US 2026/0259745 A1
(43) Pub. Date: Sep. 3, 2026

(54) SYSTEM AND METHOD FOR DEVELOPING EMOTION AWARE ADAPTIVE USER INTERFACE

(71) Applicant: King Fahd University of Petroleum and Minerals, Dhahran (SA)

(72) Inventors: Mashail Nasser Soliman ALKHOMSAN, Sakaka (SA); Malak Salim BASLYMAN, Dhahran (SA); Mohammad Rabah ALSHAYEB, Dhahran (SA)

(73) Assignee: King Fahd University of Petroleum and Minerals, Dhahran (SA)

(21) Appl. No.: 19/066,399

(22) Filed: Feb. 28, 2025

(51) Int. Cl. G06F 9/451; G06F 3/01

(52) U.S. Cl. CPC G06F 9/451; G06F 3/015

(57) ABSTRACT

A method for developing an emotion-aware adaptive user interface for a mobile application, including identifying emotional requirements of users of the mobile application and building an emotional goal model based on the emotional requirements. The emotional goal model represents relationships between emotional goals and features of the mobile application. The method also constructs an emotion transition map that defines user emotional states and transitions between the user emotional states. The method further designs a set of adaptation strategies for adapting the features of the mobile application in response to the user emotional states based on the emotional goal model and the emotion transition map. The method incorporates the set of adaptation strategies into the mobile application that determines a current user emotional state and adjusts the features based on the determined current user emotional state, and a selected adaptation strategy.

### STATEMENT REGARDING PRIOR DISCLOSURE BY THE INVENTORS

Aspects of this technology are described in an article by Mashail N. Alkhomsan, Malak Baslyman, and Mohammad Alshayeb, “A Framework for Emotion-Aware Adaptive User Interface to Improve User Experience of Smartphone Applications,” submitted to Interacting with Computers on Apr. 2, 2024, and an article by Mashail N. Alkhomsan, Malak Baslyman, and Mohammad Alshayeb, “Emotion-Driven Adaptation of Software Applications using User Requirements Notation Models,” 2024 IEEE/ACM Workshop on Multi-disciplinary, Open, and RElevant Requirements Engineering (MO2RE), Apr. 16, 2024, Lisbon, Portugal. The publications are herein incorporated by reference in their entirety.

### BACKGROUND

### Technical Field

The present disclosure is directed to adaptive user interfaces and, more particularly, to systems and methods for developing an emotion-aware adaptive user interface for mobile applications.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Rapid advancement of innovative technologies, particularly those integrated with mobile devices, has significantly elevated the value of a mobile application market. Mobile applications now serve a wide array of purposes, ranging from education and healthcare to governmental services and social networking. As a result of this revolution, many traditional business processes have been digitized, leading to an increase in the diversity of users interacting with mobile applications. However, the users often encounter challenges that affect their User Experience (UX), such as varying experience levels, which may result in frustration and, ultimately, application abandonment in favor of competitors offering a better UX.

In one conventional approach, a four-tiered pyramid has been disclosed (See: Walter, A. (2011), “Designing for emotion”, A book apart New York, incorporated herein by reference in its entirety) to describe user expectations, with functionality and reliability forming a base, and usability and emotional response at a top. While foundational tiers of functionality and reliability ensure that the mobile application meets its basic requirements, higher tiers, such as usability and emotional response, are critical for user satisfaction. These higher tiers, which pertain to human factors such as feelings and overall experience, remain underdeveloped in terms of identification, implementation, and evaluation. Therefore, significant attention must be paid to these human factors from the early stages of software development through testing and verification to ensure that emotions and user beliefs are adequately addressed in the design and implementation process.

Emotion is a fundamental dimension that shapes the UX and plays a pivotal role in technology acceptance and continued use of a product (See: Law, E., Roto, V., Vermeeren, A. P., Kort, J., & Hassenzahl, M. (2008), “Towards a shared definition of user experience”, in CHI′08 extended abstracts on Human factors in computing systems (pp. 2395-2398), incorporated herein by reference in its entirety); Levy, M. (2020), “Emotional Requirements for Well-being Applications: the Customer Journey”, 2020 IEEE first international workshop on Requirements Engineering for Well-Being, Aging, and Health (REWBAH), 35-40, incorporated herein by reference in its entirety). Traditional approaches to enhancing the UX of the mobile applications focus primarily on providing usable applications that meet the essential needs of novice users (See: Miraz, M. H., Ali, M., & Excell, P. S. 2021, “Adaptive user interfaces and universal usability through plasticity of user interface design”, Computer Science Review, 40, 100363, incorporated herein by reference in its entirety). However, the recent developments have introduced a concept of Adaptive User Interfaces (AUIs), which dynamically modify elements of their structure or features based on real-time user needs (See: Browne, D. (2016), “Adaptive user interfaces”, incorporated herein by reference in its entirety; Elsevier & Stephanidis, C. (2001), “Adaptive techniques for universal access, User Modeling and User-Adapted Interaction”, 11(1), 159-179, incorporated herein by reference in its entirety). These needs can arise as the user interacts with the mobile application, such as requiring assistance to complete a task. The AUIs are widely recognized as a promising solution for creating usable, accessible, and sustainable technology.

Despite the promising potential of the AUIs, several challenges hinder their widespread adoption. One major challenge lies in the diversity and evolving nature of the user needs, making it difficult to determine whether an automatic adaptation will optimize a user interface or cause confusion (See: Shneiderman, B. (2002), “Promoting universal usability with multi-layer interface design”, ACM SIGCAPH Computers and the Physically Handicapped, 73-74, 1-8, incorporated herein by reference in its entirety; Shneiderman, B., & Maes, P. (1997), “Direct manipulation vs. Interface agents”, Interactions, 4(6), 42-61, incorporated herein by reference in its entirety). In addition, current AUI approaches have not sufficiently incorporated emotional factors, which are an essential aspect of user interaction. Emotional considerations are user-centered encompassing emotional responses that should be achieved through the use of a specific application or a system (See: O'Brien, H. L., & Toms, E. G. (2008), “What is user engagement? A conceptual framework for defining user engagement with technology”, Journal of the American Society for Information Science and Technology, 59(6), 938-955, incorporated herein by reference in its entirety). Emotional goals vary depending on the type of mobile application and the user context. For example, while many social media applications share similar functionalities, they differ in the emotional responses they produce, such as social engagement and connectivity, which are critical for social media applications but may be lacking in simpler alternatives. Incorporating emotional requirements into the AUIs may help in achieving a more personalized and satisfying user experience, increasing user engagement and acceptance (See: Lopez-Lorca, A. A., Miller, T., Pedell, S., Sterling, L., & Curumsing, M. K. (2014), “Modelling emotional requirements”, incorporated herein by reference in its entirety).

Another critical challenge in AUI adoption is a lack of studies addressing the AUI from a requirements engineering (RE) perspective. The RE focuses on understanding both a system being developed and a broader context in which the system operates. In the context of the AUIs, the RE involves continuously eliciting and updating user requirements as they evolve over time (See: Park, K., & Lee, S.-W. (2015b), “Model-based approach for engineering adaptive user interface requirements” in Requirements Engineering in the Big Data Era (pp. 18-32), incorporated herein by reference in its entirety; Springer; Forbrig, P. (2017), “Does Continuous Requirements Engineering need Continuous Software Engineering” REFSQ Workshops, 1591886083-105399991, incorporated herein by reference in its entirety). Existing mobile UIs are primarily designed with an assumption that normal users with good cognitive abilities and comfortable environments will use them. However, the users in diverse situations, such as elderly users or those operating a smartphone while driving, may experience cognitive overload or face difficulties interacting with touch interfaces. Failing to account for these varying needs could lead to user dissatisfaction and abandonment. As such, identifying and addressing individual or situational requirements from the outset is crucial for implementing personalized, adaptive interfaces that meet the diverse needs of the users (See: Khan, I., & Khusro, S. (2020), “Towards the Design of Context-Aware Adaptive User Interfaces to Minimize Drivers' Distractions”, Mobile Information Systems, 2020, incorporated herein by reference in its entirety).

Further, developing the AUIs for mobile applications requires an in-depth understanding of dynamic factors that influence user interactions. These AUIs must be capable of adapting to changing contexts and user needs in real-time. A key challenge in this process is the elicitation of requirements that reflect the continuously evolving nature of the user experience. Conventional methods for requirements gathering often fail to account for the dynamic and personalized nature of the AUIs, which need to respond not only to functional demands but also to emotional and behavioral cues from the users.

In one conventional approach, a structured process for eliciting AUI requirements, using a three-step method known as “Area-base-consequence” is described (See: Park, K., & Lee, S, 2015a, “Requirements Elicitation for Mobile Adaptive User Interface based on Concepts from Self-Adaptive Software”, Proc. of 2015 Korea Conference on Software Engineering, incorporated herein by reference in its entirety). This process starts by gathering a domain context, properties, and constraints (AREA), followed by defining functional requirements using a MAPE-K loop, which includes monitoring, analyzing, planning, executing, and knowledge management (BASE). The final step focuses on deriving quality attributes using Self Properties (e.g., Self-Configuring, Self-Healing, Self-Optimizing, or Self-Protecting) (See: Salehie, M., & Tahvildari, L. (2009), “Self-adaptive software: Landscape and research challenges”, ACM Transactions on Autonomous and Adaptive Systems (TAAS)”, 4(2), 1-42, incorporated herein by reference in its entirety). While this method offers a systematic approach, it primarily focuses on functional and quality attributes, overlooking emotional needs and the experiences of the users, which are essential for creating truly personalized AUIs.

Further, in another conventional approach, a framework for groupware applications in complex contexts like architecture, engineering, and construction has been proposed (See: Altenburger, T., Guerriero, A., Vagner, A., & Martin, B. (2012), “Groupware requirements modeling for adaptive user interface design”, 9th European Conference on Product and Process Modelling (ECPPM 2012), Jul. 25-27, 2012, Reykjavik, Iceland, incorporated herein by reference in its entirety). This framework includes steps such as the requirements gathering (See: Garrido, J. L., Gea, M., & Rodríguez, M. L. (2005), “Requirements engineering in cooperative systems”, Requirements Engineering for Sociotechnical Systems, 226-244, incorporated herein by reference in its entirety), UI generation, user feedback, and UI improvement. However, this approach relies on static models and manual feedback processing, which limits the scalability and flexibility of the adaptation process.

Despite these advancements, a significant gap remains in the conventional approaches regarding the integration of emotional goals into the AUI requirements elicitation process. While the functional requirements are necessary to ensure the system meets the immediate tasks of the users, emotional factors such as user frustration, user satisfaction, and user engagement are equally important for enhancing the overall user experience. The AUIs need to engage individual users and adapt not only based on their behaviors, preferences, and settings but also by recognizing their emotional states.

Further, a variety of studies have explored the methods for creating AUIs that can adapt to different users, platforms, and environments, identifying which aspects of the interface, such as presentation, content, or navigation, should change in response to various conditions. The AUIs are increasingly seen as an effective approach to enhance the UX by making mobile applications more accessible. Numerous studies have looked into how AUIs can be utilized to create more accessible applications, with most adaptations focusing on specific goals such as meeting individual user needs and disabilities, supporting multiple devices and modalities, and responding to specific contexts. For instance, in one of the conventional approaches, MyUI (See: Peissner, M., Habe, D., Janssen, D., & Sellner, T. (2012), “MyUI: Generating accessible user interfaces from multimodal design patterns”, Proceedings of the 4th ACM SIGCHI Symposium on Engineering Interactive Computing Systems, 81-90, incorporated herein by reference in its entirety) is introduced, where a user interface development framework is designed to improve accessibility through adaptive UIs. MyUI employs a multimodal design pattern repository to create adaptation rules based on user preferences. However, these adaptation rules are predefined during development, and any new rules require system redeployment, which can be costly. Further, in another conventional approach, an Egoki system (See: Gamecho, B., Minón, R., Aizpurua, A., Cearreta, I., Arrue, M., Garay-Vitoria, N., & Abascal, J. (2015), “Automatic generation of tailored accessible user interfaces for ubiquitous services”, IEEE Transactions on Human-Machine Systems, 45(5), 612-623, incorporated herein by reference in its entirety) is proposed. The Egoki system such as an automatic generator of accessible UIs aimed at helping blind or cognitively impaired individuals access services in ubiquitous environments. This system uses a model-driven approach to generate the adaptive UIs based on the physical, sensory, and cognitive disabilities of the users and was evaluated through expert walkthroughs and user testing. While the system was found to be accessible and functional, there were some challenges in model creation and presentation in the final UI.

Other conventional approaches have focused on developing the AUIs that extend beyond accessibility to improve the overall user experience. For example, earlier approaches have tackled the challenge of adapting the UIs across different devices, which may have varying processing capacities, memory, battery life, and communication bandwidths, as well as different software platforms (such as Windows, iphone Operating System (iOS), and Android) (See: Chu, H., Song, H., Wong, C., Kurakake, S., & Katagiri, M. (2004), “Roam, a seamless application framework”, Journal of Systems and Software, 69(3), 209-226, incorporated herein by reference in its entirety; Viana, W., & Andrade, R. M. (2008), “XMobile: A MB-UID environment for semi-automatic generation of adaptive applications for mobile devices”, Journal of Systems and Software, 81(3), 382-394, incorporated herein by reference in its entirety). Resource-aware Application Migration (Roam) framework is proposed to address a problem of interruptions when migrating the tasks or the mobile applications between the mobile devices, facilitating a seamless experience with the adaptive UIs that allow the users to transfer the mobile applications across the devices without significant effort. Similarly, the XMobile such as an environment for creating the adaptive UIs using the model-driven approach, which generates multiple UI variations depending on device characteristics. However, unlike the Roam, a code generated by the XMobile is produced at a design time, not a run time.

In yet another conventional approach, a Triplet such as a computational framework for context-aware adaptation of interactive user interfaces is proposed (See: Motti, V. G., & Vanderdonckt, J. (2013), “A computational framework for context-aware adaptation of user interfaces”, IEEE 7th International Conference on Research Challenges in Information Science (RCIS), 1-12, incorporated herein by reference in its entirety). The framework includes a meta-model for understanding essential concepts related to adaptation and a reference framework that characterizes seven dimensions for conducting adaptations based on contextual factors, such as the platforms, the environments, or the users. However, this framework does not explicitly incorporate emotional factors. The Triplet offers a design space for systematically evaluating adaptation coverage, and it considers various development phases, ensuring consistency and comprehensive techniques for assessing platform heterogeneity and adapting to different scenarios.

In another conventional approach, CEDAR, a model-driven approach for creating the adaptive UIs for enterprise applications that can integrate with legacy systems is proposed (See: Akiki, P. A., Bandara, A. K., & Yu, Y. (2016), “Engineering adaptive model-driven user interfaces”, IEEE Transactions on Software Engineering, 42(12), 1118-1147, incorporated herein by reference in its entirety). The CEDAR approach emphasizes improving UX presentation to meet the diverse UI requirements and layout preferences of the users. The approach focuses on scalability and legacy system integration, proposing a reference architecture for developing the adaptive UIs. The CEDAR approach includes a role-based UI simplification (RBUIS) method designed to reduce feature sets and optimize layouts for improved usability. The development environment of the system, such as CEDAR Studio, supports the building of adaptive, model-driven enterprise applications. The system was evaluated from both technical and user perspectives, with results indicating that reduced-feature UIs and user-friendly layouts significantly improved end-user efficiency and satisfaction, while also seamlessly integrating into legacy systems.

In yet another conventional approach, an Adapt-UI such as an integrated development environment (IDE) for modeling and implementing self-adaptive UIs is proposed (See: Yigitbas, E., Sauer, S., & Engels, G. (2017). “Adapt-UI: An IDE supporting model-driven development of self-adaptive UIs”, Proceedings of the ACM SIGCHI Symposium on Engineering Interactive Computing Systems, 99-104, incorporated herein by reference in its entirety). This IDE allows the users to model the UI, the context, and adaptation views, generating a final UI code and context-adaptation services based on specified models. The system enables run-time adaptation to changes in a usage context. A case study involving a university library application demonstrated benefits of this approach, highlighting its effectiveness in developing the self-adaptive UIs using an Angular 2 JavaScript framework.

Further, in another conventional approach, a model-based system for generating the UIs at the run-time without requiring system redeployment is proposed (See: Hussain, J., Hassan, A. U., Bilal, H. S. M., Ali, R., Afzal, M., Hussain, S., Bang, J., Banos, O., & Lee, S. (2018), “Model-based adaptive user interface based on context and user experience evaluation”, Journal on Multimodal User Interfaces, 12(1), 1-16, incorporated herein by reference in its entirety). This system includes an authoring tool that allows the addition of new adaptation rules to an already-running system. The adaptation involves adjusting for user characteristics, environmental factors (i.e., light, noise, and location), and device usage. Context changes trigger the adaptation, which is monitored through both implicit and explicit feedback and assessed based on the user experience.

Further, in one of the conventional approaches, a method has been proposed for determining the positive effects of considering emotions in the development of the AUIs (See: Medjden, S., Ahmed, N., & Lataifeh, M. (2020), “Adaptive user interface design and analysis using emotion recognition through facial expressions and body posture from an RGB-D sensor”, PloS One, 15(7), e0235908, incorporated herein by reference in its entirety). The method involves designing and analyzing automatic, manual, and hybrid UIs for desktop applications that use red-green-blue (RGB)-Depth (D) sensors to detect the users' emotional states through facial expressions and body posture. The system identifies six basic emotions through the facial expressions and evaluates real-time emotional data captured by a Kinect sensor. Further, a comparison of the automatic, manual, and hybrid AUI versions was conducted, and findings indicated that hybrid adaptation enhanced productivity and efficiency.

Furthermore, an adaptive framework has been proposed (See: Wattearachchi, Wasura. D., Hewagamage, K. P., & Hettiarachchi, E. (2020), “A Framework to Decide Adaptive Functionalities by Considering User Emotions and the Context”, 2020 20th International Conference on Advances in ICT for Emerging Regions (ICTer), 178-183, incorporated herein by reference in its entirety) that adjusts functions based on the emotional state of the user and contextual parameters, such as the location, time, and activity. Their framework consists of a user emotions model, a context model, and an aggregator model, which collectively determine an optimal adaptive function based on both emotional and contextual information. Two user surveys were conducted to identify which emotions should be tracked and how these emotions influence the functionality of the system. The results led to the development of an emotional keyboard prototype that detects the emotions of the users through facial expressions and typing behaviors. The keyboard adapts to the emotional state of the user and the context, recommending appropriate functions such as listening to music or browsing galleries based on the emotional context of the user and situational context.

To effectively harness the emotions in the adaptive UIs, it is crucial to integrate emotional considerations directly into the requirements engineering process. Various techniques for requirements elicitation are employed in software engineering, including interviews, brainstorming sessions, and focus groups (See: Pohl, K. (2010), “Requirements engineering: Fundamentals, principles, and techniques”, Springer Publishing Company, incorporated herein by reference in its entirety). However, these traditional techniques fall short when it comes to capturing the emotional requirements due to their complexity and the fact that these requirements are individually constructed. Motivational modeling (See: Burrows, R., Lopez-Lorca, A., Sterling, L., Miller, T., Mendoza, A., & Pedell, S. (2019), “Motivational modelling in software for homelessness: Lessons from an industrial study”, 2019 IEEE 27th International Requirements Engineering Conference (RE), 297-307, incorporated herein by reference in its entirety; Lorca, A. L., Burrows, R., & Sterling, L. (2018), “Teaching motivational models in agile requirements engineering”, 2018 IEEE 8th International Workshop on Requirements Engineering Education and Training (REET), 30-39, incorporated herein by reference in its entirety; Miller, T., Pedell, S., Sterling, L., Vetere, F., & Howard, S. (2012), “Understanding socially oriented roles and goals through motivational modeling”, Journal of Systems and Software, 85(9), 2160-2170, incorporated herein by reference in its entirety), offers an approach to elicit and represent the emotional requirements in a coherent, holistic manner in relation to goals of a project. This model encompasses three distinct types of goals derived from stakeholders: do goals, which define the functional requirements of the system; be goals, which address quality aspects of the system; and feel goals, which represent the emotional experience stakeholders wish to have when interacting with the system.

The motivational modeling primarily uses structured interviews and workshops to gather the requirements. In terms of modeling, functional goals are represented by hierarchically structured parallelograms, quality goals are represented by clouds symbolizing how the system should perform, and emotional goals are represented by hearts indicating the emotional experiences stakeholders seek. These goal models serve as a visualization tool for communicating design requirements of the system, supporting exploration, experimentation, and evaluation during a design process (See: Heaven, W., & Letier, E. (2011), “Simulating and optimizing design decisions in quantitative goal models”, 2011 IEEE 19th International Requirements Engineering Conference, 79-88, incorporated herein by reference in its entirety). Further, motivational modeling has been applied (See: Taveter, K., Sterling, L., Pedell, S., Burrows, R., & Taveter, E. M. (2019), “A Method for Eliciting and Representing Emotional Requirements: Two Case Studies in e-Healthcare”, 2019 IEEE 27th International Requirements Engineering Conference Workshops (REW), 100-105, incorporated herein by reference in its entirety) to two e-healthcare case studies, recognizing a significant impact of the emotions on patient experiences (Barello, S., Triberti, S., Graffigna, G., Libreri, C., Serino, S., Hibbard, J., & Riva, G. (2016), “eHealth for patient engagement: A systematic review”, Frontiers in Psychology, 6, 2013, incorporated herein by reference in its entirety). The studies employed semi-structured interviews and workshops to identify the emotional goals in e-healthcare applications, concluding that emotional considerations are vital to a system design. The emotional goals elicited in these studies were shown to influence both the system design and architecture.

Further, an emotion-oriented requirements engineering approach is proposed (See: Curumsing, M. K., Fernando, N., Abdelrazek, M., Vasa, R., Mouzakis, K., & Grundy, J. (2019), “Understanding the impact of emotions on software: A case study in requirements gathering and evaluation”, Journal of Systems and Software, 147, 215-229, incorporated herein by reference in its entirety) to distinguish the emotional requirements from non-functional ones, focusing on the design of a smart home solution called SofiHub. Their findings emphasized that understanding user emotional needs, such as alleviating loneliness and fostering a sense of being cared for, significantly enhances the success of the technology. Despite these insights, there remains a gap between the requirements and design phases. In the realm of the requirements elicitation, machine learning techniques are becoming increasingly important. In one conventional approach, an exploratory study has been conducted (See: Stade, M., Scherr, S. A., Mennig, P., Elberzhager, F., & Seyff, N. (2019), “Don't Worry, Be Happy-Exploring Users' Emotions During App Usage for Requirements Engineering,” 2019 IEEE 27th International Requirements Engineering Conference (RE), 375-380, incorporated herein by reference in its entirety) conducted to examine acceptance of emotion tracking of the users, revealing that the users generally supported the integration of the emotion tracking into the mobile applications, despite some privacy concerns. In another conventional approach, machine learning methods have been explored (See: Jean-Charles, N., Haas, G., & Drennan, A. (2019), “Using Machine Learning to Convey Emotions During Requirements Elicitation Interviews”, Proceedings of the 2019 ACM Southeast Conference, 266-267, incorporated herein by reference in its entirety) for recognizing the emotional states using voice recordings and biofeedback data. Combining these two data types can enhance the accuracy of emotional range recognition, offering real-time emotional feedback.

However, existing AUI approaches (See: Peissner, M., Häbe, D., Janssen, D., & Sellner, T. (2012), “MyUI: Generating accessible user interfaces from multimodal design patterns”, Proceedings of the 4th ACM SIGCHI Symposium on Engineering Interactive Computing Systems, 81-90, incorporated herein by reference in its entirety; Gamecho, B., Minón, R., Aizpurua, A., Cearreta, I., Arrue, M., Garay-Vitoria, N., & Abascal, J. (2015), “Automatic generation of tailored accessible user interfaces for ubiquitous services” IEEE Transactions on Human-Machine Systems, 45(5), 612-623, incorporated herein by reference in its entirety; Akiki, P. A., Bandara, A. K., & Yu, Y. (2016), “Engineering adaptive model-driven user interfaces”, IEEE Transactions on Software Engineering, 42(12), 1118-1147, incorporated herein by reference in its entirety), generally focus on adapting the UIs based on the user preferences, accessibility needs, or the device characteristics, often relying on static profiles or predefined adaptation rules set at design time.

U.S. Patent Publication US20210011614A1 focuses on a mood-based computing experience that dynamically adjusts based on a desired or an existing state of the mood of the user. The reference aims to improve the user experience by tailoring the interface to the emotional and contextual needs. However, the reference focuses on real-time adaptation, lacking the integration of emotional requirements across a full software development lifecycle. Moreover, the reference relies on the predefined adaptation rules, limiting the flexibility. Additionally, the reference does not emphasize emotional requirements elicitation methods such as structured interviews, which are crucial for capturing deeper emotional goals from stakeholders during the design phase.

U.S. Patent Publication US20170344209A1 focuses on emotion-aware interfaces that adjust based on the emotional states of the user that are detected through physiological signals like heart rate and skin conductivity. The invention aims to create more personalized user experiences by responding to real-time emotional data, enhancing user engagement and user satisfaction. It mainly relies on the physiological signals for emotional detection, which can be intrusive and may not capture a full spectrum of the user emotions. The invention does not incorporate the emotional requirements in the early stages of the software development lifecycle, nor does it focus on structured methods for eliciting the emotional goals from the stakeholders.

Each of the aforementioned references suffers from several limitations that hinder their broader adoption. Many of these methods fail to integrate the emotional requirements throughout the entire software development lifecycle, which limits their ability to adapt to evolving the user needs over time. Additionally, some systems rely on limited emotional cues, such as physiological signals or static user profiles, which may not capture the full spectrum of emotional states, leading to less accurate or personalized experiences. Furthermore, there is often a lack of dynamic real-time adaptation, making it difficult to provide intuitive, empathetic user interfaces that respond effectively to the emotional cues in diverse contexts. These drawbacks limit the effectiveness and flexibility of current emotion-aware systems in complex, real-world applications.

Accordingly, it is one object of the present disclosure to provide a method and system for developing an Emotion-Aware Adaptive User Interface (AUI) for the mobile application by integrating real-time emotional state recognition with dynamic UI adaptation. The system includes tools for eliciting the emotional requirements from the users, a defined emotion taxonomy to guide UI adjustments, and a real-time adaptation mechanism that alters the interface based on ongoing emotional assessments. This approach ensures a personalized user experience that improves user engagement, user satisfaction, and loyalty by dynamically responding to the emotional state of the user during interactions, thus addressing the limitations of traditional static interfaces and enhancing mobile technology adoption.

### SUMMARY

In an exemplary embodiment, a method for developing an emotion-aware adaptive user interface for a mobile application is disclosed. The method includes identifying a plurality of emotional requirements of users of the mobile application. The method further includes building an emotional goal model based on the plurality of emotional requirements. The emotional goal model is representing relationships between a plurality of emotional goals and a plurality of applications features of the mobile application. The method further includes constructing an emotion transition map that defines a number of user emotional states and transitions between the number of user emotional states. The method further includes, based on the emotional goal model and the emotion transition map, designing a set of adaptation strategies for adapting application features in response to user emotional states. The method further includes incorporating the set of adaptation strategies into the mobile application. The mobile application is configured to: based on a signal obtained from a current user of the mobile application, determine a current user emotional state. The mobile application is further configured to adjust an application feature in response to the determined current user emotional state, based on an adaptation strategy selected from the set of adaptation strategies.

In another exemplary embodiment, a system for developing an emotion-aware adaptive user interface for a mobile application. The system includes processing circuitry. The processing circuitry is configured to identify a plurality of emotional requirements of users of the mobile application. The processing circuitry is further configured to build an emotional goal model based on the plurality of emotional requirements. The emotional goal model is representing relationships between a plurality of emotional goals and a plurality of applications features. The processing circuitry is further configured to construct an emotion transition map that defines a number of user emotional states and transitions between the number of user emotional states. The processing circuitry is further configured to design a set of adaptation strategies for adapting applications features in response to user emotional states based on the emotional goal model and the emotion transition map. The processing circuitry is further configured to incorporate the set of adaptation strategies into the mobile application. The mobile application is enabled to: based on a signal obtained from a current user of the mobile application, determine a current user emotional state. The mobile application is further enabled to adjust an application feature in response to the determined current user emotional state, based on an adaptation strategy selected from the set of adaptation strategies.

In yet another exemplary embodiment, a non-transitory computer readable medium having instructions stored therein that, when executed by one or more processors, cause the one or more processors to perform a method for developing an emotion-aware adaptive user interface for a mobile application is disclosed. The method includes identifying a plurality of emotional requirements of users of the mobile application. The method further includes building an emotional goal model based on the plurality of emotional requirements. The emotional goal model is representing relationships between a plurality of emotional goals and a plurality of applications features of the mobile application. The method further includes constructing an emotion transition map that defines a number of user emotional states and transitions between the number of user emotional states. The method further includes based on the emotional goal model and the emotion transition map, designing a set of adaptation strategies for adapting applications features in response to user emotional states. The method further includes incorporating the set of adaptation strategies into the mobile application. The mobile application is configured to: based on a signal obtained from a current user of the mobile application, determine a current user emotional state. The mobile application is further configured to adjust an application feature in response to the determined current user emotional state, based on an adaptation strategy selected from the set of adaptation strategies.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates a block diagram of a system for developing emotion aware adaptive user interfaces (AUIs) for one or more mobile applications, according to certain embodiments.

FIG. 1B illustrates a self-assessment manikin (SAM) tool, according to certain embodiments.

FIG. 1C illustrates components of the system, according to certain embodiments.

FIG. 1D illustrates a schematic representation of a requirements elicitation phase and an emotional requirement modeling and analysis phase of the system, according to certain embodiments.

FIG. 1E illustrates a graphical representation of an emotion taxonomy, according to certain embodiments.

FIG. 1F illustrates a schematic representation of an adaptation strategy design phase of the system, according to certain embodiments.

FIG. 1G illustrates a schematic representation of an adaptation implementation phase of the system, according to certain embodiments.

FIG. 1H illustrates a block diagram of a rule-based emotion aware adaptation approach, according to certain embodiments.

FIG. 1I illustrates a schematic representation of a comprehensive workflow of the system, according to certain embodiments.

FIG. 2 illustrates components of a processing circuitry of a server, according to certain embodiments.

FIG. 3 illustrates a flowchart of a method for developing the emotion aware AUIs for the mobile applications, according to certain embodiments.

FIG. 4 is an illustration of a non-limiting example of details of a computing hardware used in a computing system, according to certain embodiments.

FIG. 5 is an exemplary schematic diagram of a data processing system used within the computing system, according to certain embodiments.

FIG. 6 is an exemplary schematic diagram of a processor used with the computing system, according to certain embodiments.

FIG. 7 is an illustration of a non-limiting example of distributed components which may share processing with a controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system and method for integrating emotional intelligence into adaptive user interfaces (AUIs), enabling dynamic personalization based on emotional states of users. The system employs advanced algorithms to capture, analyze, and adapt to real-time emotional cues, ensuring an intuitive and context-aware interaction, which enhances user engagement, user satisfaction, and productivity by tailoring an interface behavior, a layout, and/or a functionality, etc., to meet the evolving emotional needs of the users.

The present disclosure relates to a system and method that combines emotion detection techniques with requirements engineering to design the AUIs. By integrating the emotional intelligence as a core component, the system identifies user emotions through multimodal inputs, such as facial expressions, voice tone, and interaction patterns. The identified user emotions are then integrated into interface requirements, ensuring that a user experience is both emotionally responsive and aligned with functional objectives. The present disclosure bridges a gap between technical requirements and human-centric design, delivering a seamless and empathetic user experience.

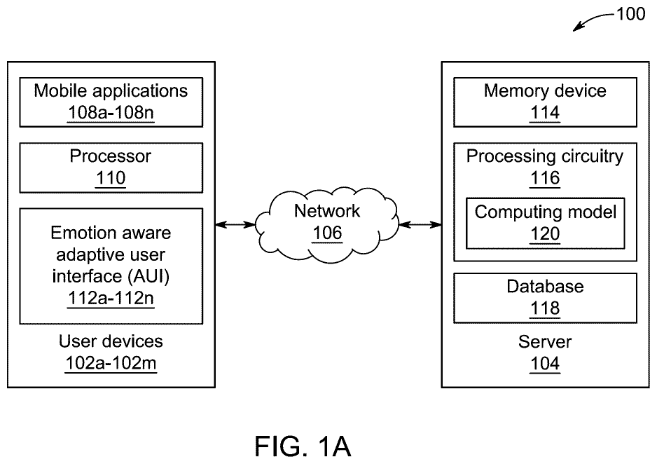

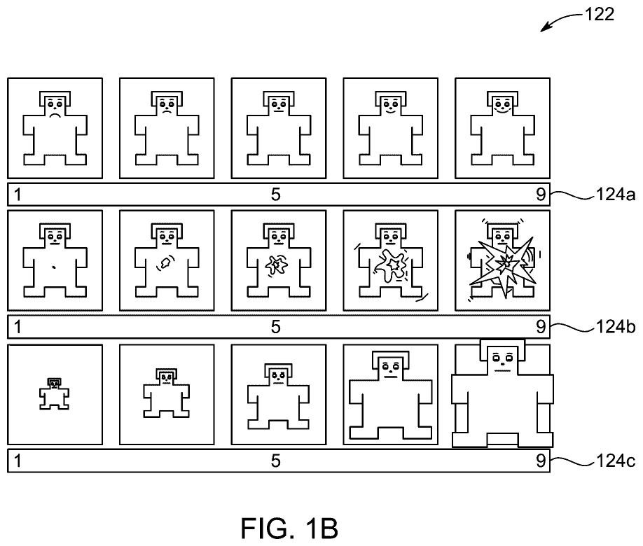

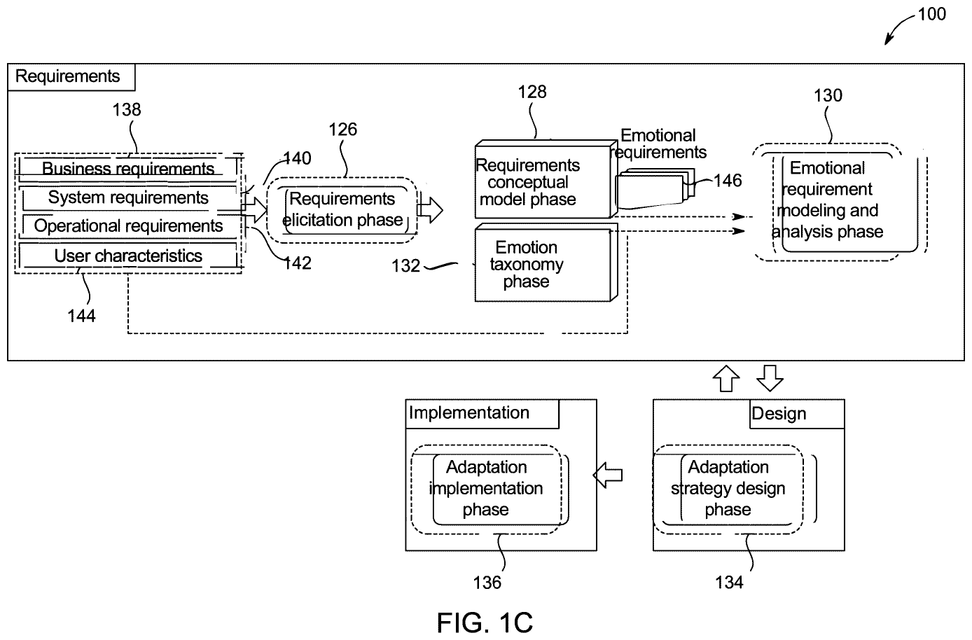

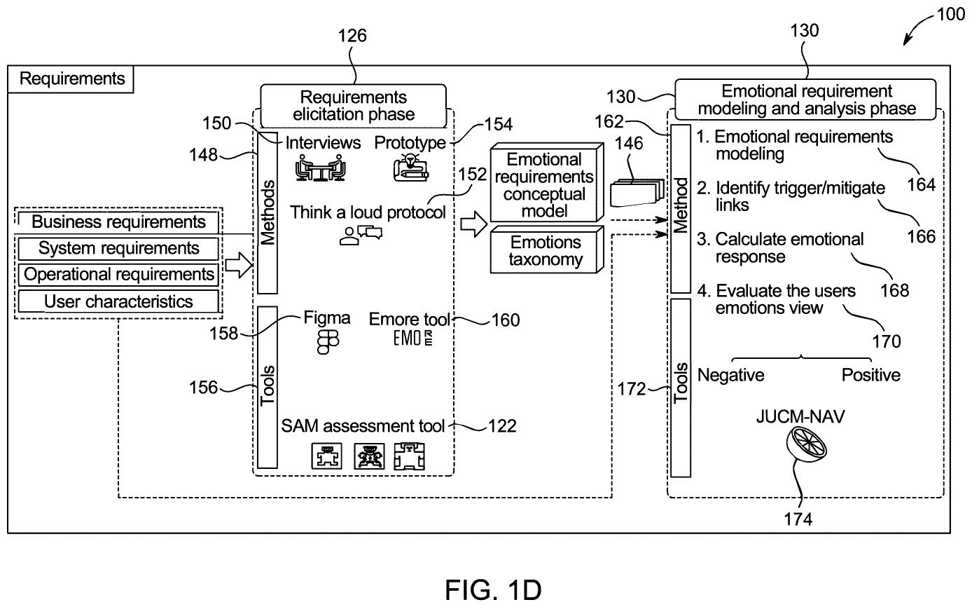

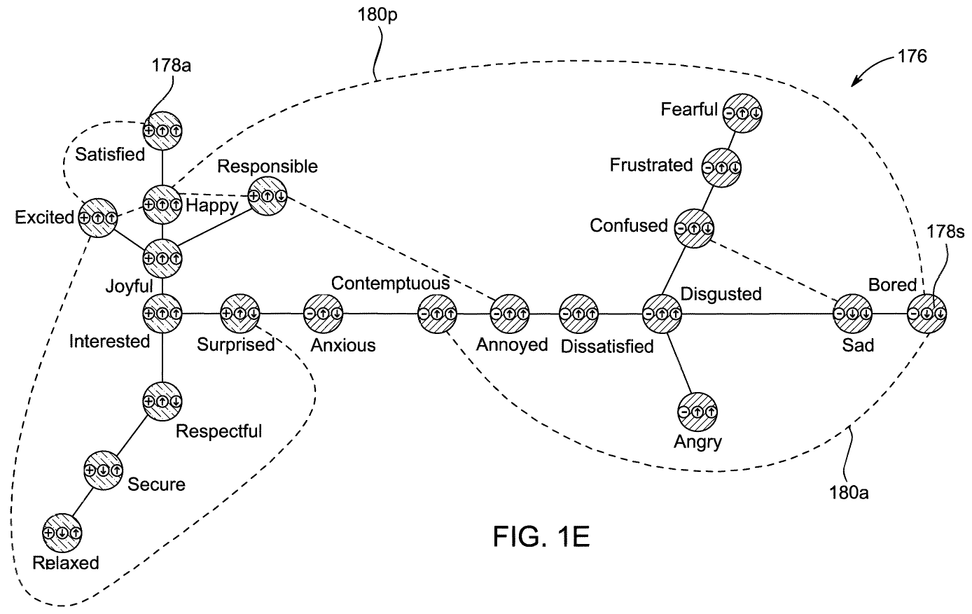

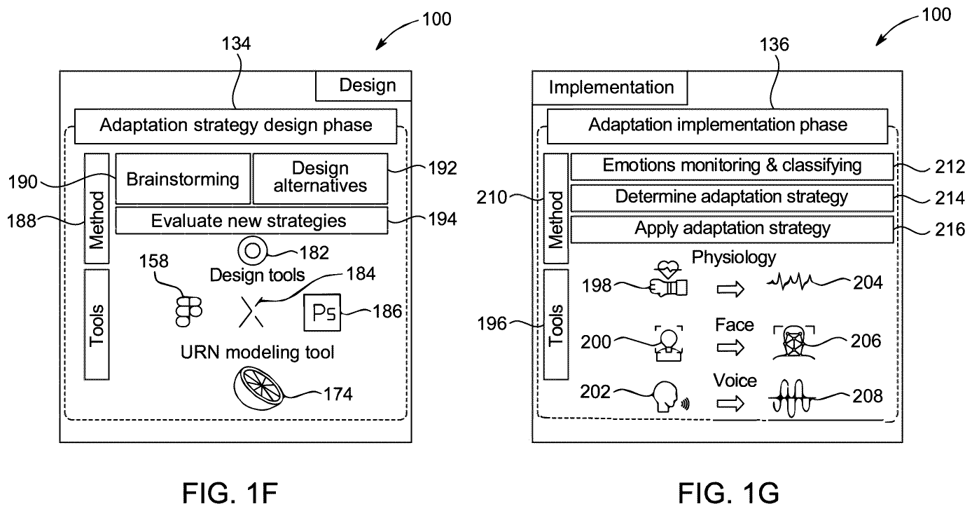

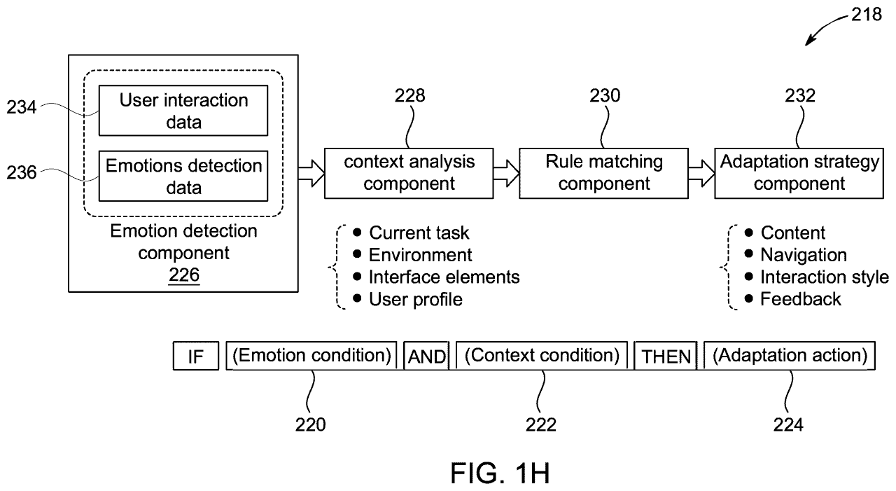

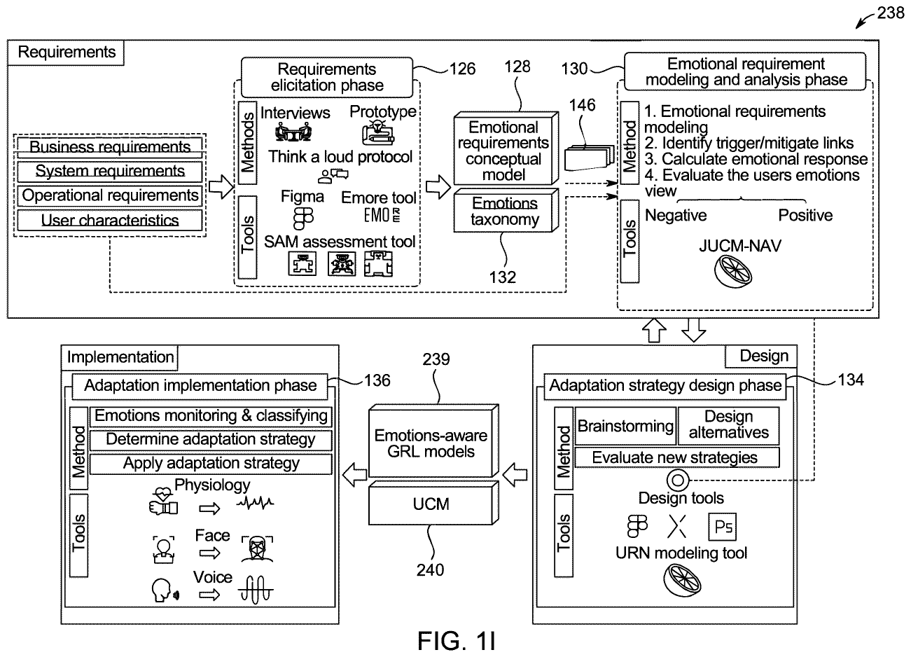

FIG. 1A illustrates a block diagram of a system 100 for developing emotion-aware AUIs 112a-112n (hereinafter collectively referred to as the AUIs 112 or the UIs 112 and individually referred to as the AUI 112 or the UI 112) for one or more mobile applications 108a-108n (hereinafter collectively referred to as the mobile applications 108 and individually referred to as the mobile application 108), according to certain embodiments. The AUIs 112 and the UIs 112 may be used interchangeably throughout a specification. The system 100 may be implemented as a framework that provides an extensive and a modular environment for capturing and analysing user emotions and providing an adaptive design of the UI 112.

As used herein, the term “emotion aware AUIs 112” may refer to the UI 112 that dynamically adjusts features, contents, and/or interaction mechanisms in response to user emotional states.

According to an embodiment, the system 100 may be configured to develop the AUIs 112 for the mobile applications 108 for enhancing a user experience (UX) by dynamically adapting the mobile applications 108 to the user emotional states. As used herein, the term “user emotional states” may refer to a real-time psychological or physiological condition of the user, such as, but not limited to, happiness, anger, sadness, frustration, and so forth. In some embodiments, the system 100 may be configured to accommodate one or more emotional responses (hereinafter collectively referred to as the emotional responses and individually referred to as the emotional response) to improve user satisfaction and user engagement. As used herein, the term “emotional responses” may refer to observable reactions elicited while the user is interacting with the corresponding mobile application 108. In other words, the emotional responses may be used to infer a reaction of the user (i.e., facial expressions 206 (as shown in FIG. 1G)) on the features (hereinafter referred to as the stimuli) of the mobile application 108. The stimuli may be designed to influence the user emotional state and may be selected based on an emotional goal model and an emotion taxonomy 176 (as shown in the FIG. 1E). The stimuli may be, for example, elements of the UI 112, content adaptation, functionality changes, feedback mechanisms, and so forth. In an exemplary embodiment, the elements of the UI 112 may refer to changes in color schemes, layout, font sizes, use of animations, and so forth. Further, the content adaptation may refer to modifying a presentation of text, images, multimedia content, and so forth. The functionality changes may refer to adjusting the complexity of interactions, providing different levels of assistance, or offering alternative workflows. The feedback mechanisms may refer to varying a type and a frequency of feedback provided to the user.

Further, in an embodiment, the system 100 may be configured to integrate emotional considerations into a design process of the UI, ensuring that the mobile applications 108 are functionally sound, aesthetically pleasing, and emotionally resonant with the users (hereinafter collectively referred to as the users and individually referred to as the user).

In an embodiment, the system 100 may include user devices 102a-102m (hereinafter collectively referred to as the user devices 102 and individually referred to as the user device 102) and a server 104. In such embodiment, the user device 102 and the server 104 may be connected to each other through a network 106.

According to an embodiment, the network 106 may be a data network such as, but not limited to, the Internet, a local area network (LAN), a wide area network (WAN), a metropolitan area network (MAN), and so forth. Embodiments of the present invention are intended to include or otherwise cover any type of the data network, including known, related art, and/or later developed technologies. In some embodiments, the network 106 may be a wireless network, such as, but not limited to, a cellular network and may employ various technologies including enhanced data rates for global evolution (EDGE), a general packet radio service (GPRS), and so forth. Embodiments of the present invention are intended to include or otherwise cover any type of the wireless network, including known, related art, and/or later developed technologies.

Further, the user device 102 may be a device used by the user to interact with the stimuli of the mobile applications 108 that may be installed within the user device 102. The user device 102 may also be used by the user to provide emotional and behavioural feedback about the stimuli of the mobile application 108 during an elicitation process. The user device 102 may be for example, but not limited to, a mobile device, a smart phone, a tablet, a portable computer, a laptop, a desktop, a smart device, and so forth. Embodiments are intended to include or otherwise cover any type of the user device 102, including known, related art, and/or later developed technologies. Further, the user device 102, as may be readily appreciated by a person skilled in the art, is merely intended to illustrate and not to limit what may encompass the user device 102, such as, but not limited to, an instant messaging sending device, a short message service (SMS) transmitting device, and/or other messaging devices that may include, but not limited to, a text, graphics, symbols and/or other identifiable communications. In an embodiment, the user device 102 may be a multipurpose device, such that an operation in accordance with the present system 100 is merely one of many (e.g., two or more) features that may be provided by the user device 102.

According to an embodiment, the user device 102 may further include the mobile applications 108. The mobile application 108 may be a computer readable program installed on the user device 102 for executing functions associated with the system 100 on the user device 102. The mobile application 108 may be any software application such as, but not limited to, a banking application, a fitness application, a gaming application, a learning application, and so forth. Embodiments of the present invention are intended to include or otherwise cover any type of the mobile applications 108 including known related art and/or later developed technologies. The mobile application 108 may serve as a primary interface for the users to interact with the stimuli, providing the feedback on the UX. The mobile applications 108 may dynamically adjust the UI 112 based on real-time emotional data processed by the system 100. Further, in an embodiment, the mobile application 108 may utilize built-in sensors to determine the user emotional state and adjust the stimuli of the mobile application 108 based on the user emotional state. In an embodiment, the mobile application 108 may have inbuilt tools 156 (as shown in FIG. 1D) that facilitate real-time emotional feedback collection during the user interaction with the mobile application 108. In a preferred embodiment, the tools 156 may be, but not limited to, a Figma 158 (as shown in the FIG. 1D), an Emotion-Oriented Requirements Engineering (EmORE) tool 160 (as shown in the FIG. 1D), a self-assessment manikin (SAM) tool 122 (as shown in FIG. 1B). The tools 156 may be designed to support an elicitation process. In an embodiment, the tools 156 may be built to enable the user to provide qualitative feedback and quantitative feedback on the mobile application 108. In an embodiment, the qualitative feedback may be the emotional responses of the user to the stimuli of the mobile applications 108. The qualitative feedback may be collected through an audio input, a text input, observed behaviour cues, and so forth. In an exemplary embodiment, the audio input may be open-ended verbal feedback of the user that may be collected by conducting interviews 150 (as shown in the FIG. 1D) or a think-aloud protocol 152 (as shown in the FIG. 1D) through a microphone 202 (as shown in the FIG. 1G) of the user device 102.

Further, in an exemplary embodiment, the text input may be, but is not limited to, thoughts, emotional responses, and so forth that may be typed by the user in the mobile application 108 using one of the input devices of the user device 102. The input devices may be, but not limited to, a stylus, a keyboard, and so forth. Also, in an exemplary embodiment, the observed behaviour cues may be non-verbal behaviours such as, but not limited to, pauses, tone changes, hesitations, and so forth that may be captured indirectly through sensors installed within the user device 102. The sensors may be, but not limited to, the microphone 202, a camera 200 (as shown in the FIG. 1G), and so forth. In an exemplary embodiment, the user may interact with the tools 156 by typing answers to questions of the interviews 150 in a text field, selecting responses from predefined options or rating scales, recording verbal answers through one of the microphones 202 of the user device 102 or a built-in voice recording feature of the tools 156.

Further, in an embodiment, the quantitative feedback may be provided by the user through self-assessment manikin (SAM) scales 124a-124c (as shown in the FIG. 1B) of the SAM tool 122. As used herein, the term “SAM scales 124a-124c” may enable the users to rate the user emotions in a quantitative manner. In an exemplary embodiment, the quantitative feedback may be in form of ratings that may be provided along emotional dimensions such as, but not limited to, a pleasure (valence), an arousal, a dominance, and so forth. In an embodiment, the quantitative feedback may be provided by the user by interacting with the SAM scales 124a-124c directly on a touchscreen of the user device 102. In another embodiment, the quantitative feedback may be provided by the user through input methods such as, but not limited to, a mouse, the stylus, the keyboard, and so forth. In an exemplary embodiment, the SAM scales 124a-124c may be represented as visual representations and enable the users to provide a numerical rating for each of the emotional dimensions.

In another embodiment, the tools 156 may also be installed into an operator device (not shown) to collect the qualitative feedback and the quantitative feedback of the mobile applications 108 from the user device 102. In such embodiment, the tools 156 may assist the operators to conduct elicitation sessions for the users. The operators may be, but not limited to, requirement engineers, designers, and so forth. The elicitation sessions may be focused on evoking the emotional responses of the users to the stimuli of the mobile applications 108. In an embodiment, the elicitation sessions may be conducted for gathering and analyzing the emotional responses of the users during a requirements elicitation phase 126 (as shown in FIG. 1C). In such embodiment, the users may provide qualitative feedback such as the open-ended verbal feedback about emotional reactions to the features or usage scenarios of the mobile applications 108 in the elicitation sessions. In an embodiment, the tools 156 may also collect the quantitative feedback including quantitative emotion ratings from the SAM scales 124a-124c.

The tools 156 may combine the qualitative feedback and the quantitative feedback (hereinafter referred to as the feedback) to incorporate the user emotions into an emotion-oriented requirements engineering process. The tools 156 may be configured to transmit the feedback of the user emotions onto the server 104.

In yet another embodiment, the tools 156 may be located on the server 104 and interact with the user device 102 and the operator device. In another embodiment, the tools 156 may be a standalone application that may be installed on the operator device.

The user device 102 may further comprise a processor 110. The processor 110 may be configured to receive and/or transmit the emotional data associated with the system 100 over the network 106. Further, the processor 110 may be configured to process the emotional data associated with the system 100, in an embodiment. The processor 110 may be, but not limited to, a programmable logic control unit (PLC), a microcontroller, a microprocessor, a computing device, a development board, and so forth. Embodiments of the present invention are intended to include or otherwise cover any type of the processor 110 including known, related art, and/or later developed technologies.

The user device 102 may include the AUI 112 that may be configured to enable the users to interact with the mobile applications 108 installed within the user device 102. The AUI 112 may be adjusted based on the emotional data processed by the system 100. The AUI 112 may be, but not limited to, a digital display, a touch screen display, a graphical user interface, and so forth. Embodiments of the present invention are intended to include or otherwise cover any type of the AUI 112 including known, related art, and/or later developed technologies.

In an embodiment, the server 104 may include a memory device 114, a processing circuitry 116, and a database 118. The memory device 114 may be a non-transitory data storage medium that may be configured to store computer-executable instructions for controlling operations of the system 100. The memory device 114 may be, but not limited to, a random-access memory (RAM) device, a read only memory (ROM) device, a flash memory, and so forth. Embodiments of the present invention are intended to include or otherwise cover any type of the memory device 114 including known, related art, and/or later developed technologies.

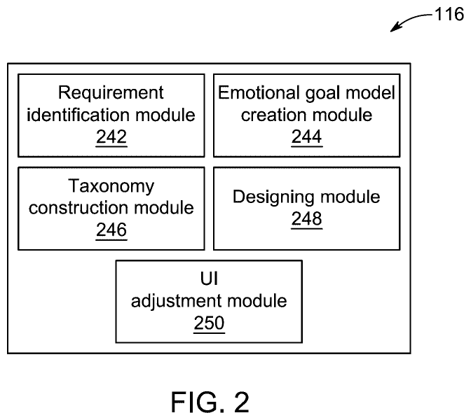

Further, the processing circuitry 116 may be connected to the memory device 114 to execute the computer-executable instructions to perform the operations associated with the system 100. The processing circuitry 116 may be, but not limited to, the programmable logic control unit (PLC), the microcontroller, the microprocessor, the computing device, the development board, and so forth. Embodiments of the present invention are intended to include or otherwise cover any type of the processing circuitry 116, including known, related art, and/or later developed technologies. In an embodiment, the processing circuitry 116 may be explained in detail in conjunction with FIG. 2.

In an embodiment, the processing circuitry 116 may be configured with a computing model 120 that may be trained for classification and clustering of the emotional responses. In a preferred embodiment, the computing model 120 may include a first trained neural network and a second trained neural network. The first trained neural network may be, but not limited to, a decision tree, a support vector machine, a random forest, a Naïve Bayes, and so forth. In a preferred embodiment, the first trained neural network may be a K-nearest neighbours (KNN) classifier. Embodiments of the present invention are intended to include or otherwise cover any type of the first trained neural network, including known related art and/or later developed technologies. Further, the second trained neural network may be, but not limited to, a hierarchical clustering, a spectral clustering, a gaussian mixture model (GMM), and so forth. In a preferred embodiment, the second trained neural network may be a K-means clustering algorithm. Embodiments of the present invention are intended to include or otherwise cover any type of the second trained neural network, including known related art and/or later developed technologies.

In an embodiment, the database 118 may be configured to store the emotional responses of the users, emotional requirements 146 (as shown in the FIG. 1C) of the user, a dataset, the first trained neural network, the second trained neural network, dataset and so forth. In another embodiment, the server 104 may include multiple databases (not shown) to store the emotional responses of the users, the emotional requirements 146 of the user, the dataset, the first trained neural network and the second trained neural network. According to embodiments of the present invention, the database 118 may be, for example, but not limited to, a centralized database, a distributed database, a personal database, an end-user database, a commercial database, a structured query language (SQL) database, a non-SQL database, an operational database, a relational database, a cloud database, an object-oriented database, a graph database, and so forth. Embodiments of the present invention are intended to include or otherwise cover any type of the database 118, including known, related art, and/or later developed technologies that may be capable of data storage and retrieval.

FIG. 1B illustrates a SAM tool 122, according to certain embodiments. The SAM tool 122 may include a set of three pictorial SAM scales 124a-124c (hereinafter referred to as the SAM scales 124) that are designed specifically to assess the emotional responses of the user based on the emotional dimensions such as the pleasure (valence), the arousal and the dominance. In an exemplary embodiment, the SAM tool 122 may include a visual manikin with different facial expressions 206 (as shown in the FIG. 1G) and body postures representing different user emotional states. In such exemplary embodiment, the user may select an image that reflects the emotional state of the user in response to a corresponding stimulus, such as interacting with the mobile application 108 (as shown in the FIG. 1A). For example, a first image of the emotional dimension such as the pleasure (valence) on a first SAM scale 124a represents a distressed user. The user emotional states associated with the distressed user may include, but not limited to, panic, irritation, disgust, crisis, and so forth. A last image of the pleasure (valence) on the first SAM scale 124a represents a happy user, and the user emotional state associated with the happy user may be fun, delight, relaxation, satisfaction, and so forth. In another exemplary embodiment, a first image of the emotional dimension, such as arousal on a second SAM scale 124b, represents a calm user, and the user emotional state associated with the calm user may include, but is not limited to, relaxation, idleness, meditation, and so forth. A last image of the arousal on the second SAM scale 124b represents an exuberant user, and the user emotional state associated with the exuberant user may include, but is not limited to, excitation, rage, anger, agitation and so forth.

In another exemplary embodiment, a first image of the emotional dimension, such as the dominance on a third SAM scale 124c, represents the user feeling a lack of agency and control, and the user emotional state associated with the user may include, but is not limited to, subordination, withdrawal, resignation and so forth. A last image of the dominance on the third SAM scale 124c represents the user who is dominant and in control of the situation, and the user's emotional state associated with the dominant user may include, but is not limited to, control, influence, being important, and so forth.

FIG. 1C illustrates components of the system 100, according to certain embodiments. The components may work together to develop emotionally intelligent mobile applications 108 (as shown in the FIG. 1A) by systematically incorporating the emotional considerations into the design of the UI 112 (as shown in the FIG. 1A) and an adaptation process. The components may be the requirements elicitation phase 126, a requirements conceptual model phase 128, an emotional requirement modeling and analysis phase 130, an emotion taxonomy phase 132, an adaptation strategy design phase 134 and an adaptation implementation phase 136.

The requirements elicitation phase 126 may be a process to gather and understand requirements, expectations and constraints of the users and stakeholders regarding the corresponding mobile applications 108. The requirements may be, but not limited to, business requirements 138, system requirements 140, operational requirements 142 and user characteristics 144. The business requirements 138 may be high level goals that focuses on an overall objective of the mobile applications 108 such as, but not limited to, profitability, marketability and so forth. The business requirements 138 may ensure that the mobile applications 108 meet a need of a business. Further, the system requirements 140 may be technical specifications that may be required to support the business requirements 138 and the operational requirements 142. The system requirements 140 focus on various aspects such as, but not limited to, a performance, a scalability and an integration with other systems. The operational requirements 142 may define ongoing operations of the mobile applications 108 once the corresponding mobile applications 108 are deployed, covering aspects such as, but not limited to, maintenance, updates, monitoring and support. Further, the user characteristics 144 may be associated with a behaviour of the user, preferences of the user, and needs of the user.

In an embodiment, the requirements elicitation phase 126 may be designed to capture emotional expectations and desires associated with the mobile application 108. The emotional expectations and the desires associated with the mobile application 108 may be captured by using a Pleasure, Arousal, and Dominance (PAD) model. As used herein, the PAD model may be represented by the SAM tool 122 (as shown in the FIG. 1B), which quantifies the user emotions across the emotional dimensions of the pleasure, the arousal and the dominance using a visual scale for each dimension. In the requirements elicitation phase 126, the tools 156 (as shown in the FIG. 1D) may be used to gather the emotional expectations and the desires directly from the users through surveys, the feedback and behavioural analysis. The gathered emotional expectations and the desires may be then prioritized along with functional requirements of the mobile application 108. For example, in a meditation application, the users may expect to feel calm and relaxed, which corresponds to low arousal and high pleasure. The meditation application may then prioritize the features that may help the users in achieving the user emotional states like soothing sounds or calming visuals.

Further, the requirements conceptual model phase 128 may provide a structured way for classifying and organizing the emotional requirements 146 into emotional goals. The emotional goals may guide the design of the mobile application 108 that aligns with a desired emotional outcome for the user. For example, if the requirements elicitation phase 126 identifies that the users feel frustrated when using a certain feature, then the requirements conceptual model phase 128 may define the emotional goal such as, reduce user frustration by simplifying the UI 112.

Further, the emotional requirement modeling and analysis phase 130 may be designed to model the elicited emotional requirements 146 by using a goal-oriented approach. The goal-oriented approach may involve a step of creating a diagram that illustrates a relationship between the emotional goals (i.e., the emotional expectations and the desires) and the stimuli of the mobile application 108. The relationship between the emotional goals and the stimuli of the mobile application 108 may be analysed to identify conflicts, contributions, or dependencies. In an aspect, conflicts may arise when one feature of the mobile application 108 tries to meet conflicting emotional goals. In another aspect, the contributions may refer to how well the feature of the mobile application 108 supports the emotional goals. In an aspect, the dependencies may refer to how the emotional goals depend on the features of the mobile application 108. By analysing the relationship between the emotional goals and the stimuli of the mobile application 108, a design of the mobile application 108 may be refined to maximize the user satisfaction.

The emotion taxonomy phase 132 may be designed to capture key user emotional states and relationships of the key user emotional states that are specific to a type of the mobile application 108 being used. In an aspect, the emotion taxonomy phase 132 maps out the user emotional states such as, the excitement, the irritation, joy, and so forth and relationships of the user emotional states with one another. The emotion taxonomy phase 132 serves as a foundation for understanding an emotional landscape of the mobile application 108 and guides a development of adaptation strategies that promote positive emotional experiences (e.g., making the mobile application 108 with the fun, reward or the satisfaction) and mitigate negative emotional experiences (e.g., reducing confusion or the irritation).

The adaptation strategy design phase 134 may be used to design the adaptation strategies based on insights received from the emotional requirement modeling and analysis phase 130 and the emotion taxonomy phase 132. The adaptation strategies may enable the mobile application 108 to adjust in the real-time based on the user emotional state. In an aspect, the adaptation strategies may be designed by using use case maps (UCM) 240 (as shown in FIG. 1I). Further, the adaptation strategies may be validated with the users to ensure that the adaptation strategies are effective in changing the user emotional state.

Further, the adaptation implementation phase 136 may be used to enable real time adaptation of the UI 112. In an aspect, the adaptation implementation phase 136 may utilize an emotion detection model such as a machine learning model to detect the user emotional state on various cues such as, but not limited to, the facial expressions 206 (as shown in the FIG. 1G), the voice tone 208 (as shown in the FIG. 1G), interaction patterns and so forth. Once the user emotional state is detected, the UI 112 of the mobile application 108 is adapted immediately to respond appropriately, thereby providing a personalized and emotionally responsive experience.

FIG. 1D illustrates a schematic representation of the requirements elicitation phase 126 and the emotional requirement modelling and analysis phase 130 of the system 100, according to certain embodiments. The requirements elicitation phase 126 of the system 100 may utilize an EmORE approach for eliciting, modeling, and analyzing the emotional goals. The EmORE approach may be utilized to capture and integrate the user emotions into the requirements elicitation phase 126. In an aspect, an elicitation process in the EmORE approach may involve eliciting the emotional responses from the users through the qualitative feedback and the quantitative feedback. The qualitative feedback may be collected from the user by conducting the elicitation sessions through various methods 148 such as, the interviews 150, the think-aloud protocol 152, a prototype 154, and so forth with the users focused on the features or the usage scenarios of the mobile application 108 (as shown in the FIG. 1A). Embodiments of the present invention are intended to include or other cover any type of the methods 148 of the elicitation sessions including known related art and/or later developed technologies. In the prototype 154, a model or a working version of the mobile application 108 may be created and presented to the users to gather the feedback. In the elicitation sessions, the users may be provoked to provide open-ended feedback on the emotional reactions and impressions for each context of the mobile application 108.

Further, the quantitative feedback may be collected from the SAM tool 122 (as shown in the FIG. 1B) that may enable the users to provide the ratings on the emotional dimensions such as, the pleasure (valence), the arousal, and the dominance using a SAM technique. The collection of the qualitative feedback and the quantitative feedback may enable the operators to capture both subjective emotional experiences and objective measurements. The EmORE aims to enable more consistent and bias-free elicitation of subjective user emotions by combining qualitative answers with quantitative SAM-based ratings. The quantitative feedback facilitates an automated classification and analysis while the qualitative feedback provides a grounding human context.

In an embodiment, the requirements elicitation phase 126 may also utilize the tools 156 to automate the elicitation process and supports the operators in capturing, analyzing, and interpreting the emotional responses. In an exemplary embodiment, the tools 156 may be, but not limited to, the Figma 158, the EmORE tool 160, the SAM tool 122 and so forth. Embodiments of the present invention are intended to include or other cover any type of the tools 156 for the elicitation process including known related art and/or later developed technologies.

Further, the qualitative feedback and the quantitative feedback may be recorded in the database 118 (as shown in the FIG. 1A). In a preferred embodiment, the qualitative feedback and the quantitative feedback may include PAD ratings that may be provided by the users. Once the qualitative feedback and the quantitative feedback are recorded, the tools 156 may utilize the first trained neural network to predict discrete emotional labels based on the qualitative feedback and the quantitative feedback. As discussed in the FIG. 1A, the first trained neural network may be the KNN classifier that is well-suited to handle non-linear relationships between the PAD ratings and the user emotional states. In an embodiment, the first neural network may be trained by using the dataset that is created by collecting the feedback from the users interacting with the mobile applications 108 across different use cases. Here, the first neural network may be trained by using the dataset for associating the discrete emotion labels with the PAD ratings. In an aspect, each interaction may be having the qualitative feedback, the quantitative feedback and the discrete emotion labels that may be assigned manually or through an automated means.

Further, in an exemplary embodiment, the dataset may be created by mapping the PAD ratings to the discrete emotion labels using Russell and Mehrabian's three-factor theory of emotions. In an aspect, 21 emotion terms may be selected from a comprehensive list of 151 emotion terms, which are most relevant to the UXs in the mobile applications 108. In such aspect, a synthetic dataset of 1000 data points may be generated using a programming language such as, a Python, based on means and standard deviations provided for the 21 emotions. Each data point includes three PAD values (ranging from −1 to +1) and an associated emotion label (e.g., the joy, frustration, the anger). The dataset ensures a balanced representation across a PAD space, enabling effective training of the first neural network. As used herein, the term “PAD space” refers to a three-dimensional (3D) representation of the user emotional state based on the pleasure (P), the arousal (A) and the dominance (D) dimensions of the PAD model. For instance, the user emotional states like the “anger” and the “joy” are equally represented to prevent bias during classification.

Upon creation of the dataset, the dataset may be divided into an 80% training set and a 20% testing set. The first neural network may be trained on the training set for predicting the discrete emotion labels and evaluated the first trained neural network using standard performance metrics such as, but not limited to, a precision, a recall, F1-score, and an accuracy on the testing set. In an aspect, the first trained neural network may achieve the accuracy of 94% on the testing set. In an exemplary embodiment, a detailed breakdown of the performance metrics per emotion shows that the precision and the recall were generally high (1.00 for most emotions), indicating accurate identification of both true positives and true negatives. In an aspect, a “bored” emotion presented a slightly lower recall (0.33), suggesting potential challenges in accurately capturing all instances of the specific user emotional state. However, overall high F1-scores (above 0.90 for the most emotions) demonstrate a robustness of the first trained neural network. Also, a confusion matrix analysis revealed that misclassifications occurred primarily between similar emotions (e.g., the “anger” and “annoyance”) but not between distinct categories. This robustness ensures reliable emotion labels even in nuanced cases.

Optionally, the predicted emotion labels may be validated through a human-in-the-loop validation process. At an end of each elicitation session, the predicted emotion labels may be presented to the users for confirmation which allows the users to correct the misclassifications, ensuring both reliability and validity. For example, if the user disagrees with a prediction of the “frustration”, then the prediction may be adjusted to the “annoyance”, refining an output of the first trained neural network and minimizing biases in an automated classification.

Further, the second trained neural network may be configured to perform the clustering by identifying patterns and the relationships between the discrete emotion labels across the users. In a preferred embodiment, the second trained neural network may be the K-means clustering algorithm. The K-means clustering algorithm may be having an ability to group similar PAD data points into clusters, revealing underlying structures in the emotional responses. Upon creation of the clusters, the clusters may be assessed using a metric that measures a separation between the clusters, such as a silhouette score. In an aspect, the silhouette score of 0.314 may indicate some degree of separation between the clusters.

Further, clustering results may be visualized to facilitate interpretation and understanding by the operators. The clustering results may be visualized using methods such as, but not limited to, graphs, heatmaps, scatter plots, and so forth. Embodiment of the present invention are intended to include or otherwise cover any type of the methods for visualizing the clustering results including known related art and/or later developed technologies.

These visualizations may group the user emotions based on common emotional themes, making easier to analyse the patterns and trends in the emotional data. For example, these visualizations may be instrumented in identifying emotional hotspots and informing a design of the adaptation strategies such as, altering the elements of the UI, personalizing the features, enhancing the usage scenarios, and so forth.

Further, in the emotional requirement modeling and analysis phase 130, a method 162 includes various steps of modeling and analysis of the emotional requirements 146. A first step 164 of emotional requirement modeling includes defining soft goals to represent the emotional requirements 146 such as, reduce anxiety, increase trust, enhance engagement, and so forth, using a framework such as, an emotion-aware goal-oriented requirements language (GRL) model 239 (as shown in the FIG. 1I), that may allow modeling and analysis of the emotional requirements 146. In an aspect, the emotion-aware GRL model 239 is supported by tools 172 such as, JUCM-Nav tool 174 that is a graphical modeling and analysis tool. The JUCM-Nav tool 174 may be capable to provide a user-friendly interface for visualizing the soft goals, the emotional goals (i.e., the emotional requirements 146), and the relationships.

In an extended EmORE approach, a new entity called actor's emotions may be introduced to represent the emotional requirements 146 of the users separately from traditional system goals, ensuring a clear management of the emotional requirements 146. In an aspect, the emotional requirements 146 may be represented as the soft goals and the stimuli such as, the features of the mobile application 108 may be modeled as intentional elements in the emotion-aware GRL model 239. The intentional elements may represent triggers or mitigating factors for the soft goals. An impact of the intentional elements on the soft goals may be assessed and the assessed impact may be represented as contribution links. In an aspect, the contribution links may include trigger links and mitigate links. The trigger links may activate specific emotions and the mitigate links may reduce certain user emotional states.

For example, in a healthcare application, a progress bar feature may have the mitigate link to the soft goal such as, reduce the anxiety while a live chat feature may have the trigger link to the soft goal such as “increase the trust”. By dynamically evaluating the relationships between the soft goals and the intentional elements, the features of the mobile application 108 may be adapted to align with the user emotional state, ensuring an emotionally intelligent and user-centred experience. The integration of the emotional goals into the emotion-aware GRL model 239 through systematic enhancements may enable the system 100 to address the functional requirements and the emotional requirements 146 effectively.

In an exemplary embodiment, the emotional requirement modelling may involve a step of creating a formal model for the soft goals and the stimuli using the emotion-aware GRL model 239. In an aspect, a new emotion-aware GRL model 239 may be created. Once the soft goals and the stimuli are modeled, the emotional requirement modelling may involve a step 166 of identifying the trigger links or the mitigate links. This step 166 includes analysing the relationship between the stimuli and the soft goal to determine how each feature of the mobile application 108 affects the user emotions. For analysing the relationship, the contribution links may be established within the emotion-aware GRL model 239 to map the relationships between the stimuli and the soft goals. If stimulus triggers the emotion, the contribution link labelled as “trigger” is created. Conversely, if the stimulus mitigates the emotion, the contribution link labelled as “mitigate” is created. Table 1 represents a mapping of elements of the emotional requirements 146 to elements of the emotion-aware GRL model 239. For example, the users or subjects are modeled as the actors, the emotions as the soft goals, the stimuli as the intentional elements, and the trigger and the mitigate relationships as the contribution links.

TABLE 1
Mapping Emotional Requirements 146 Elements
to the emotion-aware GRL model 239 Elements

| Emotional Requirements | Emotion-aware GRL |
|---|---|
| 146 Elements | model 239 Elements |
| User/Subject | Actor |
| Emotions | Soft Goals |
| Stimulus | Intentional Elements |
| Trigger | Contribution Link |

Further, an analysis phase includes a step 168 of calculating the emotional response. This step 168 includes quantifying the emotional response for each emotion-stimuli pair using methods such as, the PAD ratings. For each emotion-stimulus pair, the PAD ratings are normalized to a consistent scale, facilitating a calculation of a scalar product of normalized PAD vectors of the stimulus and the emotion. The scalar product quantifies a similarity or an alignment between an emotional impact of the stimulus and a desired user emotional state. In an aspect, a higher scalar product indicates a stronger positive correlation between the stimulus and a target emotion, which in turn suggests that the stimulus is likely to contribute to achieving the desired emotional outcome. The emotion response may be computed using an equation (1) as below:

$${( U , V )}_{R} = {Σ}_{i = 1}^{n} {U}_{i} {V}_{i} \qquad ( 1 )$$

where U and V are emotion vectors represented as (p₁,a₁,d₁) and (p₂,a₂,d₂), respectively. Also, p denotes the pleasure, a denotes the arousal, and d denotes the dominance.

Further, the analysis phase includes a step 170 of evaluation of a view of the user emotions by categorizing the emotional goals as a first additional emotional goal and a second additional emotional goal. The first additional emotional goal may represent a positive emotional state, and the second additional emotional goal may represent a negative emotional state. The positive emotional state may contribute to a positive mood soft goal and the negative emotional state may contribute to a negative mood soft goal. Further, thresholds may also be defined for the positive mood soft goal and the negative mood soft goal to determine acceptable satisfaction levels. If a satisfaction level of the negative mood soft goal exceeds the corresponding threshold, then adjustments are made by introducing the stimuli to mitigate the negative emotional state. Similarly, if the satisfaction level of the positive mood soft goal falls below the threshold, a new stimulus (i.e., additional features) may be designed to enhance the positive emotional state. Further, the emotion-aware GRL model 239 is re-evaluated with the adjustments, ensuring that the context of the mobile application 108 aligns with the desired emotional outcomes. This iterative process of evaluation and refinement ensures an optimization of the user emotional states in a modelled scenario.

FIG. 1E illustrates a graphical representation of the emotion taxonomy 176, according to certain embodiments. The emotion taxonomy 176 may be designed for human-computer interaction (HCI). The emotion taxonomy 176 may be an emotion transition map that may be constructed and validated using a multi-method approach that incorporated insights from a systematic literature review, an expert input, and user studies.

In an embodiment, the emotion transition map may define a number of primary user emotional states 178a-178s (hereinafter collectively referred to as the user emotional states 178 and individually referred to as the user emotional state 178) and transitions 180a-180p (hereinafter referred to as the transitions 180) between the number of the primary user emotional states 178.

In an aspect, a comprehensive literature review may be conducted to identify the user emotional states that may be frequently examined in the HCI. Over 100 user emotional states may be identified across various domains. Further, statistical analysis may be conducted that reduce the user emotional states to 32 key user emotional states, selected for their prevalence, generalizability, and relevance to the HCI. For example, in reviewing a literature on gaming interfaces, the emotions like the “frustration” and the “satisfaction” may found to be commonly experienced, emphasizing a need to include these emotions in the emotion taxonomy 176.

In an aspect, an iterative Delphi study was conducted with 12 HCI and UX professionals, including both academics and industry practitioners, for gathering the feedback to refine a set of the user emotional states for the emotion taxonomy 176. In a first round, experts rated 32 user emotional states on their relevance to the HCI using a 5-point Likert scale. Top 24 user emotional states may be shortlisted for a second round of ratings, resulting in a refined set of 20 user emotional states.

In an aspect, a PAD framework may be used to model the 20 user emotional states and the corresponding transitions 180 of the 20 user emotional states. In such aspect, each user emotional state may be assigned with 3D PAD values ranging from −1 to +1. In an aspect, new PAD ratings may be developed for the emotions such as the “trust”, “amused” and the “calm” through an input from psychology experts, resulting a final set of the primary user emotional states 178 to 21 for the emotion taxonomy 176. In a preferred embodiment, the primary user emotional states 178 may be, but not limited to, satisfied, excited, joyful, interested, respectful, secure, relaxed, happy, responsible, surprised, anxious, contemptuous, annoyed, dissatisfied, fearful, frustrated, confused, disgusted, angry, sad, bored, and so forth.

In an embodiment, each core primary user emotional state 178 may be represented as an emotion node in the emotion taxonomy 176 and each emotion node may be mapped to a corresponding point in the 3D PAD space. This mapping provides a quantitative representation of each primary user emotional state 178, enabling a calculation of distances between the primary user emotional states 178.

Further, a minimum spanning tree algorithm may be used to connect the points within the 3D PAD space to form a network that may represent the transitions 180 of the primary user emotional states 178. In a preferred embodiment, the minimum spanning tree algorithm may be a Kruskal's minimum spanning tree algorithm. The minimum spanning tree algorithm ensures that a resulting tree includes edges (i.e., the transitions 180) that represent most likely changes between the primary user emotional states 178. In an aspect, shorter edges may indicate more likely transitions 180.

To validate the emotion taxonomy 176, user studies may be conducted in healthcare and gaming contexts to validate an ability of the emotion taxonomy 176 to represent emotional journeys of the users. For example, in the healthcare application, the users interacting with a patient portal often transitioned from the “anxiety” to the “calm” when given clear explanations. These transitions 180 aligned well with the emotion taxonomy 176, supporting its relevance. Similarly, in the gaming application, the emotions of players such as the “frustration” shifted to the “excitement” upon solving challenges, demonstrating an applicability of the emotion taxonomy 176 in dynamic scenarios. In an aspect, newly observed transitions (not shown) may be integrated into the emotion taxonomy 176 iteratively. The resulting emotion taxonomy 176 is robust and contextually grounded, combining the insights from the literature, the expert feedback, dimensional modeling, and real-world validation. The emotion taxonomy 176 provides a systematic way to represent the primary user emotional states 178 and the transitions 180, enabling a design of the emotionally intelligent mobile applications 108 for diverse HCI applications.

FIG. 1F illustrates a schematic representation of the adaptation strategy design phase 134 (hereinafter referred to as the design phase 134) of the system 100, according to certain embodiments. The design phase 134 may showcase a structured and an iterative process that transforms the insights from emotional models (i.e. emotional requirements model) into validated design alternatives. Each stage of the process may be designed to identify, model, and evaluate potential adaptations based on the user emotions. The process begins by analysing an emotional goal model to map the stimuli of the mobile application 108 (as shown in the FIG. 1A) to the soft goals. Concurrently, the emotion taxonomy 176 (as shown in the FIG. 1E) may be used to categorize the primary user emotional states 178 (as shown in the FIG. 1E), identifying the relationships and the transitions 180 (as shown in the FIG. 1E) between the primary user emotional states 178. For example, if the emotional goal model shows that a complex navigation in the mobile application 108 triggers the user frustration and the emotion taxonomy 176 classifies the user frustration as a negative high arousal state, then the adaptation strategy needs to focus on redesigning the navigation application to move the users toward a neutral or positive emotional state.

Based on the insights derived from the emotional goal model and the emotion taxonomy 176, various adaptation strategies may be designed and mapped to emotional triggers. As used herein, the term “emotional triggers” may refer to specific events, the stimuli or the situations that evoke the emotional response in the user. The emotional triggers may cause positive emotions and negative emotions. For example, to mitigate the user frustration that may be caused by the complex navigation, the adaptation strategy may be designed to implement a simpler navigation structure that may include a simple menu with fewer options and a search bar to quickly locate the features. Also, a mock-up of the simplified UI 112 (as shown in the FIG. 1A) may be created using design tools 182 such as, the Figma 158, an Axure 184, a photoshop 186, the JUCM-Nav tool 174 and so forth, allowing the designers to visualize the designed adaptation strategies.

Further, a method 188 may be utilized for generating the adaptation strategies. In an embodiment, the method 188 may include a step 190 of employing brainstorming techniques for generating multiple adaptation strategies to address the emotional triggers identified during an emotional requirement modelling process. By exploring different approaches, this step 190 ensures that the adaptation strategies are not only effective but comprehensive. For example, in addition to simplifying the navigation, alternative strategies are brainstormed, such as: providing tutorial overlays to guide first-time users, including personalized shortcuts based on a user behaviour, offering voice-assisted navigation to reduce a cognitive load, and so forth.

The method 188 includes a step 192 of modeling of the designed adaptation strategies using the UCM 240 in the JUCM-Nav tool 174 for providing a visual and a narrative representation of an adaptation logic, indicating steps involved in adapting the UI 112 based on a particular emotional trigger. This formal representation facilitates communication and analysis of the adaptation strategies. For example, for a simplified navigation strategy, the UCM 240 depicts the mobile application 108 detecting the frustration through slow task completion times, triggering the adaptation of the UI 112 to display a breadcrumb trail and simplify menus, logging the user interactions post-adaptation to measure effectiveness.

Further, in an aspect, the method 188 includes a step 194 of evaluating the generated adaptation strategies based on a feasibility, an effectiveness, and a user impact. The feasibility depicts “can the adaptation be implemented within technical constraints of the mobile application 108”. The effectiveness depicts “how effectively does the adaptation achieve the desired emotional outcome”, and the user impact depicts “what is an overall impact of the adaptation on the UX, considering both emotional and usability aspects”. The evaluation step 194 may utilize the design tools 182 such as, the Figma 158 for visual assessment and the JUCM-Nav tool 174 for analysing a modelled adaptation logic.

Further, validated emotion aware design alternatives ready may be obtained for implementation. These alternatives align with emotional objectives while ensuring technical and usability requirements are met. For example, the final validated emotion aware design alternatives may include a simplified navigation structure, a tutorial overlay for the first-time users and positive feedback messages, such as “Great job! You are almost there!” when tasks are completed successfully.

FIG. 1G illustrates a schematic representation of the adaptation implementation phase 136 of the system 100, according to certain embodiments. The adaptation implementation phase 136 may utilize one or more tools 196 to collect physiological signals of the user. The tools 196 may be the sensors such as, but not limited to, a heartbeat sensor 198, the camera 200, the microphone 202, and so forth. In an exemplary embodiment, the heartbeat sensor 198 may be utilized to capture a signal of a heart rate 204 of the user. In another exemplary embodiment, the camera 200 may be utilized to capture the facial expressions 206 of the user. In yet another embodiment, the microphone 202 may be utilized to capture the signal of a voice tone 208 of the user.

Further, the adaptation implementation phase 136 may implement a method 210 for implementing the adaptation strategies on the UI 112 (as shown in the FIG. 1A) of the mobile application 108 (as shown in the FIG. 1A). The method 210 includes a step 212 of monitoring and classifying a current emotional state of a current user. The method 210 further includes a step 214 of determining the adaptation strategy from the multiple adaptation strategies based on the monitored current emotional state of the current user by using a rule-based emotion aware adaptation approach 218 (explained in detail in FIG. 1H). Further, the method 210 includes a step 216 of applying the determined adaptation strategy for adjustment of the features of the mobile application 108.

FIG. 1H illustrates a block diagram of the rule-based emotion aware adaptation approach 218, according to certain embodiments. The rule-based emotion aware adaptation approach 218 may be implemented to dynamically adjust the UX based on an emotion detection and contextual factors. In an embodiment, the rule-based emotion aware adaptation approach 218 may be implemented based on a set of rules that follow an IF-THEN-ELSE structure such as, IF (an emotion condition 220) AND (a context condition 222) THEN (an adaptation action 224). As used herein, the term “emotion condition 220” refers to the current emotional state of the current user, the term “context condition 222” refers to a current situation or an environment of the current user and the term “adaptation action 224” specifies what changes to make based on the detected current emotional state of the current user and the contextual factors.

For example, IF the user is feeling frustrated (the emotion condition 220), AND the user is trying to complete a complex task (the context condition 222), THEN simplify an interface layout to reduce the complexity (the adaptation action 224).

The rule-based emotion aware adaptation approach 218 may include an emotion detection component 226, a context analysis component 228, a rule matching component 230 and an adaptation strategy component 232. The emotion detection component 226 may be configured to determine the current emotional state of the current user. In an aspect, the emotion detection component 226 may be configured to detect simple emotional states such as, the sadness. In another aspect, the emotion detection component 226 may be configured to detect complex emotional states such as a combination of frustration and anxiety. The emotion detection component 226 may also consider an emotion intensity that allows for more nuanced rule activation. In an exemplary embodiment, the emotion detection component 226 may be configured to collect user interaction data 234. The user interaction data 234 may be, but not limited to, the text input, mouse clicks, browsing history, and so forth. In an exemplary embodiment, the text input may be messages of the user, typed responses, written communication and so forth. For example, the user typed a complaint message that “I cannot find what I need” may indicate the frustration or the confusion.

The emotion detection component 226 may also be configured to collect emotion detection data 236 based on the signal obtained from the user of the mobile application 108 (as shown in the FIG. 1A). The signal may be the physiological signal measured from the user through the sensors. The physiological signal may include a signal of the facial expression 206, a body posture, the voice tone 208, a speech pattern, the heart rate 204, a heart rate variability, a breathing rate, a breathing pattern, an eye movement, a blink rate, a body temperature, a skin color, and skin conductance of the user. Upon receiving the physiological signal, the emotion detection component 226 may be configured to analyse the physiological signal using emotion recognizing techniques. In an embodiment, emotion-recognizing techniques may include sentiment analysis, facial expression algorithms, heart rate analysis, and so forth. In an exemplary embodiment, the sentiment analysis technique may be a natural language processing (NLP) technique that may be used to analyse the text input for an emotional tone. The sentiment analysis technique may determine whether words of the user convey positive emotions, negative emotions, or neutral emotions. For example, a statement like “this is so frustrating” may be identified a negative sentiment, indicating the frustration. Similarly, the facial expression algorithm may use the machine learning model and computer vision techniques to detect the emotions from the facial expressions 206 in real-time. For example, a face of the user showing raised eyebrows, and an open mouth may indicate surprise or the confusion.

Further, the emotion detection component 226 may be configured to determine the current emotional state of the current user and intensity of the emotion based on combined insights of the user interaction data 234 and the emotion detection data 236. The combined insights of the user interaction data 234 and the emotion detection data 236 may be processed by algorithms to classify the emotional state and intensity of the emotional state. For example, the emotion detection component 226 identifies which emotion the user is experiencing. The emotion may be happiness, sadness, anger, or a more complex emotion. Along with identifying the emotion of the user, the emotion detection component 226 identifies the intensity of the emotion. For example, the user showing a mild frown and typing “I do not know what to do” may indicate low level frustration.

The context analysis component 228 may be configured to perform context analysis for determining situational factors that affect a relevance of the emotion. The situational factors may include, but not limited to, a current task of the user of the mobile application 108, an interface element with which the user is interacting, user profile characteristics with respect to an experience level and a preference of the user, and an environment factor with respect to a time, a location, and a device that the user is using. For example, the user is trying to fill out a detailed survey, however the user is encountering issues with the navigation. Similarly, a novice user is interacting with the interface that is designed for more experienced users.

The rule matching component 230 may be configured to compare data associated with the detected emotional state and data associated with the contextual analysis to corresponding predefined rules stored in the database 118 (as shown in the FIG. 1A). In an exemplary embodiment, the emotion condition 220 of the predefined rules may be compared against the data of the detected emotional state and the intensity of the emotional state. Similarly, the contextual condition 222 of the predefined rules may be compared against the data associated with the contextual analysis. The rule matching component 230 may be configured to trigger the adaptation action 224 to improve the UX if the emotion condition 220 and the contextual condition 222 of the predefined rules are matched with the data of the detected emotional state and the intensity and the data associated with the contextual analysis respectively.

The adaptation strategy component 232 may be configured to execute the adaptation strategy associated with a matched rule for adjusting the features of the mobile application 108. The adjustment of the features of the mobile application 108 may include modifying content (e.g., recommending different articles, changing a tone of a language), adjusting the navigation and interface layout (e.g., highlighting important elements, simplifying the navigation), changing an interaction style or input methods (e.g., switching to a voice input, providing more detailed instructions), delivering tailored feedback or support messages (e.g., offering encouragement, providing helpful tips).

In an embodiment, an updated UI 112 of the mobile application 108 may be presented to the user on the user device 102. In an embodiment, the emotion detection component 226 and the context analysis component 228 may continuously monitor the user interaction, the physiological signals, and contextual data to dynamically adapt the UX based on evolving emotions and the context.

In an embodiment, the features of the mobile application 108 may be adjusted dynamically in real time by continuously monitoring the emotional triggers such as, user frustration, user satisfaction, or confusion. The selected adaptation strategy may be executed using run-time reconfiguration techniques, ensuring that changes occur without interrupting the UX.

For example, the user is interacting with a learning application for coding lessons. The emotion detection component 226 detects confusion emotions based on user interaction patterns such as repeatedly revisiting a same code example or attempting incorrect solutions multiple times. The detected confusion may prompt the adaptation that reconfigures the UI 112 by highlighting a “need help” button prominently, increasing a pop-up tutorial with a step-by-step guidance, and so forth. Conversely, in another example, where the user is working out using a fitness application and the emotion detection component 226 detects satisfactory emotions based on the facial expressions 206 (as shown in the FIG. 1G) triggers the adaptation. The adaptation strategy component 232 reconfigures the UI 112 by displaying a motivational message such as “Great job”, suggesting more advanced workout routines, and so forth.

FIG. 1I illustrates a schematic representation of a comprehensive workflow 238 of the system 100, according to certain embodiments. The comprehensive workflow 238 presents an innovative integration of the components (as discussed above in the FIG. 1C) such as, the requirements elicitation phase 126, the requirements conceptual model phase 128, the emotional requirement modeling and analysis phase 130, the emotion taxonomy phase 132, the adaptation strategy design phase 134 and the adaptation implementation phase 136, for enabling real-time adaptation of the UI 112 (as shown in the FIG. 1A). The components may be capable to analyze and address an intricate relationship between the user emotions and interactions with the mobile applications 108 (as shown in the FIG. 1A).

The comprehensive workflow 238 ensures a structured approach to incorporate the emotional considerations throughout a software development lifecycle by utilizing the emotion-aware GRL model 239 to model the emotional requirements 146 and the UCMs 240 for designing the adaptation strategies. In an aspect, the emotion-aware GRL model 239 may be an extended version of a traditional GRL, that may be enhanced to include emotional aspects in the design of the mobile application 108. The emotion aware GRL model 239 may integrate the emotional goals alongside traditional functional and non-functional goals to capture and analyze how the features of the mobile application 108 influence the user emotional states.

Further, the adaptation strategies may be encapsulated within the UCMs 240. The UCMs 240 may be a structured visualization tool that models how the mobile application 108 adapts to the user interactions or the user emotional states. The UCM 240 may represent the triggers such as, the detected emotions, a sequence of actions, and specific adaptations.

FIG. 2 illustrates components of the processing circuitry 116 of the server 104, according to certain embodiments. The components may be a requirement identification module 242, an emotional goal model creation module 244, a taxonomy construction module 246, a designing module 248 and a UI adjustment module 250.

According to an embodiment, the requirement identification module 242 may be configured to identify the emotional requirements 146 (as shown in the FIG. 1C) of the users of the mobile application 108 (as shown in the FIG. 1A). In an embodiment, the emotional requirements 146 of the users may be identified by using the quantitative feedback and the qualitative feedback collected from the users on the mobile application 108. In such embodiment, the quantitative feedback and the qualitative feedback may be collected from the users through the various tools 156. In a preferred embodiment, the qualitative feedback and the quantitative feedback may be the PAD ratings. In an embodiment, the requirement identification module 242 may be configured to identify the emotional requirements 146 by inferring the discrete emotion labels using the combined qualitative feedback and the quantitative feedback through the first trained neural network. In an embodiment, the requirement identification module 242 may be configured to infer the discrete emotion labels through the first trained neural network by associating a set of the discrete emotion labels with the PAD ratings.

Further, in an embodiment, the requirement identification module 242 may be configured to identify the patterns and the relationships between the discrete emotion labels across the users by using the second trained neural network. Based on the identified patterns and the relationships, the requirement identification module 242 may be configured to perform the clustering on the discrete emotion labels by using the second trained neural network for identifying the emotional requirements 146 of the user. The requirement identification module 242 may be configured to transmit the emotional requirements 146 to the emotional goal model creation module 244 and the designing module 248.

As an example, suppose a healthcare application collects SAM-based PAD ratings and the open-ended verbal feedback from the users about the features such as, an “appointment booking” and a “consultation chat”. Based on the feedback, the first trained neural network may map the PAD ratings for the “consultation chat” to the discrete emotion labels such as, the “happiness” and the “satisfied,” and map the PAD ratings for the “appointment booking” to the “anxiety.” Further, the second trained neural network may identify that the “anxiety” is frequently linked to delays in the “appointment booking” across the users. Accordingly, the second trained neural network may form a cluster of similar emotion labels to define the emotional requirements 146. The emotion labels that are clustered in cluster 1 are the “anxiety” and the “frustration” and the emotional requirements 146 will be reducing user stress. The emotion labels in a cluster 2 are the “trust” and the “happiness” and the emotional requirements 146 will be enhancing user confidence.

The emotional goal model creation module 244 may be communicatively coupled to the requirement identification module 242. The emotional goal model creation module 244 may be configured to build the emotional goal model that represents the relationships between the emotional goals and the stimuli of the mobile application 108 based on the emotional requirements 146 received from the requirement identification module 242. The emotional goal model creation module 244 may be configured to build the emotional goal model by using the emotion-aware GRL model 239. In an embodiment, the emotional requirements 146 may be represented as the soft goals and the stimuli of the mobile application 108 may be represented as the intentional elements. The emotional goal model creation module 244 may be configured to assess impacts of the intentional elements on the soft goals. The emotional goal model creation module 244 may be configured to assess the impacts of the intentional elements on the soft goals by analysing the relationship between the intentional elements and the soft goals to determine how each feature of the mobile application 108 affects the user emotions.

The emotional goal model creation module 244 may further be configured to model the assessed impacts as the contribution links, to build the emotional goal model representing the relationships between the emotional goals and the stimuli of the mobile application 108. The contribution links may be the trigger links and the mitigate links. Further, in an embodiment, the emotional goal model creation module 244 may further be configured to calculate the emotional response for each emotion-stimuli pair using the methods such as, the PAD ratings. The emotional response may be calculated by the scalar product of the normalized PAD vectors of the stimulus and the emotion.

The emotional goal model creation module 244 may be configured to define the first additional emotional goal and the second additional emotional goal. The first additional emotional goal may represent the positive emotional state, and the second additional emotional goal may represent the negative emotional state. Further, the emotional goal model creation module 244 may be configured to assess the impacts of the soft goals on the first additional emotional goal and the second additional emotional goal. In an exemplary embodiment, the positive emotional state may contribute to the positive mood soft goal and the negative emotional state may contribute to the negative mood soft goal. Further, the thresholds may also be defined for the positive mood soft goal and the negative mood soft goal to determine the acceptable satisfaction levels. The emotional goal model creation module 244 may be configured to compare the satisfaction level of the negative mood soft goal with the corresponding threshold. In an embodiment, if the satisfaction level of the negative mood soft goal exceeds the corresponding threshold, then the emotional goal model creation module 244 may be configured to perform the adjustments by introducing the stimuli to mitigate the negative emotional state. In another embodiment, if the satisfaction level of the positive mood soft goal falls below the corresponding threshold, then the emotional goal model creation module 244 may be configured to design the new stimulus to enhance the positive emotional state. The emotional goal model creation module 244 may be configured to transmit the emotional goal model to the designing module 248.

The taxonomy construction module 246 may be configured to construct the emotion transition map that defines the number of the primary user emotional states 178 and the transitions 180 between the number of the primary user emotional states 178. In an embodiment, the taxonomy construction module 246 may be configured to identify the primary user emotional states 178 that may be having a higher probability than other emotional states of the user, as the number of the primary user emotional states 178. In such embodiment, the primary user emotional states 178 may be identified based on the feedback received from various experts (explained in the FIG. 1E). The taxonomy construction module 246 may be configured to map the primary user emotional states 178 to the set of points within the 3D PAD space for representing the primary user emotional states 178 as the emotion nodes.

The taxonomy construction module 246 may be configured to arrange the emotion nodes into the network to construct the emotion transition map, with branches of the network representing the transitions 180 between the primary user emotional states 178. In an embodiment, the taxonomy construction module 246 may be configured to connect the set of points within the 3D PAD space to form the network by using the minimum spanning tree algorithm. The taxonomy construction module 246 may be configured to transmit the emotion transition map to the designing module 248.

The designing module 248 may be communicatively coupled to the requirement identification module 242, the emotional goal model creation module 244, and the taxonomy construction module 246. The designing module 248 may be configured to design the adaptation strategies for adapting the features of the mobile applications 108 in response to the primary user emotional states 178. The designing module 248 may be configured to design the adaptation strategies based on the emotional goal model and the emotion transition map. In an embodiment, the adaptation strategies may be mapped to the emotional triggers that may cause the positive emotional state and the negative emotional state.

In an embodiment, the designing module 248 may be configured to validate the designed adaptation strategies based on the feasibility, the effectiveness, and the user impact by using the design tools 182. Further, the designing module 248 may be configured to generate the validated adaptation strategies that may be ready for implementation. In an embodiment, the adaptation strategies may be encapsulated within the UCMs 240 where each UCM 240 represents a specific adaptation strategy, detailing a sequence of actions and responses of the mobile application 108 that may be required to implement the adaptation based on a particular emotional trigger. The UCMs 240 provide a structured and a visual representation of the adaptation logic, facilitating communication, analysis, and the implementation.

The UI adjustment module 250 may be communicatively coupled to the designing module 248. The UI adjustment module 250 may be configured to incorporate the adaptation strategies into the mobile application 108. In an embodiment, the UI adjustment module 250 may be configured to determine the current emotional state of the current user based on the user interaction data 234 and the emotion detection data 236 obtained from the user of the mobile application 108. Upon receiving the user interaction data 234 and the emotion detection data 236, the UI adjustment module 250 may be configured to analyse the user interaction data 234 and the emotion detection data 236 using the emotion recognizing techniques. Further, the UI adjustment module 250 may be configured to enable the mobile application 108 to determine the user emotional state and intensity of the emotion based on the combined insights of the user interaction data 234 and the emotion detection data 236.

Further, the UI adjustment module 250 may be configured to perform the context analysis for determining the situational factors of the mobile application 108. The UI adjustment module 250 may be configured to select the adaptation strategy from the adaptation strategies, based on the determined situational factors and the determined current emotional state of the current user by using the rule-based emotion aware adaptation approach 218. The UI adjustment module 250 may be configured to enable the mobile application 108 to execute the selected adaptation strategy for adjusting the features of the mobile application 108.

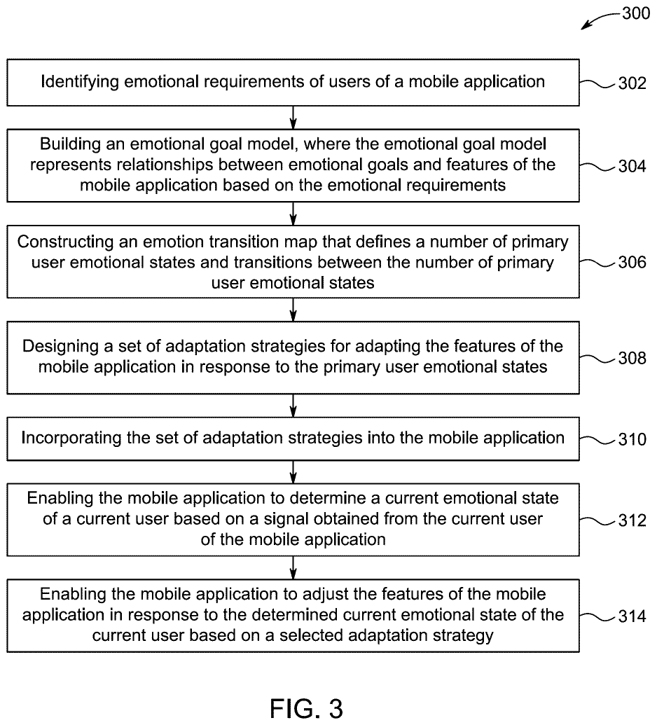

FIG. 3 illustrates a flowchart of a method 300 for developing the AUIs 112 (as shown in the FIG. 1A) for the mobile applications 108 (as shown in the FIG. 1A). The method 300 includes a series of steps. These steps are only illustrative, and other alternatives may be considered where one or more steps are added, one or more steps are removed, or one or more steps are provided in a different sequence without departing from the scope of the present disclosure.

At step 302, the method 300 includes identifying the emotional requirements 146 (as shown in the FIG. 1C) of the users of the mobile application 108. The step 302 may involve collecting the quantitative feedback and the qualitative feedback from the users on the mobile application 108. The collected quantitative feedback and the qualitative feedback may be the PAD ratings. The step 302 may further involve inferring the discrete emotion labels by using the collected quantitative feedback and the qualitative feedback through the first trained neural network. The first trained neural network may be the K-nearest neighbors (KNN) classifier that is trained for associating the set of discrete emotion labels with the set of PAD ratings. The step 302 may also involve clustering the inferred discrete emotion labels through the second trained neural network to obtain the emotional requirements 146. The second trained neural network may be the K-means clustering algorithm that conducts the clustering by identifying the patterns and the relationships between the discrete emotion labels across the users.

At step 304, the method 300 includes building the emotional goal model based on the emotional requirements 146 by using the emotion-aware GRL model 239 (as shown in the FIG. 1I). The emotional goal model represents the relationships between the emotional goals and the stimuli of the mobile application 108. The stimuli of the mobile application 108 may include the elements of the UI 112 (as shown in the FIG. 1A) such as, the color scheme, the layout, the font size, and the animation, the content adaptation with respect to the presentation of the text, the images, and the multimedia contents, the functionality change with respect to the complexity of the interactions, the different level of the assistance, and the alternative workflow, and the feedback mechanism that varies the type and the frequency of the feedback provided to the users of the mobile application 108.

The step 304 may involve representing the emotional requirements 146 as the soft goals and the stimuli as the intentional elements for assessing the impacts of the intentional elements on the soft goals. The step 304 of assessing the impacts may involve analysing the relationship between the intentional elements and the soft goals to determine how each feature of the mobile application 108 affects the user emotions. Further, the assessed impacts are modeled as the contribution links, to build the emotional goal model that represents the relationships between the emotional goals and the stimuli of the mobile application 108.

Further, the method 300 may also include calculating the emotional response for each emotion-stimuli pair using the methods such as, the PAD ratings. This step may involve calculating the emotional response by the scalar product of the normalized PAD vectors of the stimulus and the emotion. The method 300 may also include evaluating the view of the user emotions by defining the first additional emotional goal and the second additional emotional goal. The first additional emotional goal may represent the positive emotional state, and the second additional emotional goal may represent the negative emotional state. This step may involve assessing the impacts of the soft goals on the first additional emotional goal and the second additional emotional goal.

At step 306, the method 300 includes constructing the emotion transition map that defines the number of the primary user emotional states 178 and the transitions 180 between the number of the primary user emotional states 178. The step 306 may involve identifying the primary user emotional states 178 that may be having the higher probability than other emotional states of the user, as the number of the user emotional states 178. In a preferred embodiment, the primary user emotional states 178 may be, but not limited to, satisfied, excited, joyful, interested, respectful, secure, relaxed, happy, responsible, surprised, anxious, contemptuous, annoyed, dissatisfied, fearful, frustrated, confused, disgusted, angry, sad, bored, and so forth. The primary user emotional states 178 may be identified based on the feedback received from the various experts. The step 306 may also involve mapping the primary user emotional states 178 to the set of points within the 3D PAD space for representing the primary user emotional states 178 as the emotion nodes. Further, the step 306 involves arranging the emotion nodes into the network to construct the emotion transition map, with branches of the network representing the transitions 180 between the primary user emotional states 178, where the arranging step includes applying the minimum spanning tree algorithm to connect the set of points within the 3D PAD space to form the network. The minimum spanning tree algorithm may be the Kruskal's minimum spanning tree algorithm.

At step 308, the method 300 includes designing the adaptation strategies for adapting the stimuli of the mobile application 108 in response to the primary user emotional states 178 based on the emotional goal model and the emotion transition map. The step 308 may involve mapping the adaptation strategies to the emotional triggers that may cause the positive emotional state and the negative emotional state. The step 308 may further involve validating the designed adaptation strategies based on the feasibility, the effectiveness, and the user impact by using the design tools 182. The validated adaptation strategies may then be derived as the set of adaptation strategies that may be ready for implementation. In an embodiment, the adaptation strategies may be encapsulated within the UCMs 240 (as shown in the FIG. 1I) where each UCM 240 represents a specific adaptation strategy, detailing the sequence of the actions and the responses of the mobile application 108 that may be required to implement the adaptation based on the particular emotional trigger.

At step 310, the method 300 includes incorporating the set of adaptation strategies into the mobile application 108. The step 310 involves incorporating the set of adaptation strategies into the mobile application 108 based on the current emotional state of the current user and contextual analysis data.

At step 312, the method 300 includes enabling the mobile application 108 to determine the current emotional state of the current user based on the signal obtained from the user of the mobile application 108. The step 312 of determining the emotional state may involve continuously obtaining the signal from the user and assessing the current emotional state of the current user in a real time manner, to determine the emotional state of the user. The obtained signal may be the physiological signal measured from the user through the sensor or reported by the user. The physiological signal includes the signal with respect to the facial expression 206 (as shown in the FIG. 1G), the body posture, the voice tone 208 (as shown in the FIG. 1G), the speech pattern, the heart rate 204 (as shown in the FIG. 1G), the heart rate variability, the breathing rate, the breathing pattern, the eye movement, the blink rate, the body temperature, the skin color, and the skin conductance of the user.

At step 314, the method 300 includes enabling the mobile application 108 to adjust the stimuli of the mobile application 108 in response to the determined current emotional state of the current user based on the selected adaptation strategy. The step 314 of adjusting the stimuli of the mobile application 108 may involve performing the context analysis to obtain the situational factors of the mobile application 108. The situational factors may be the current task of the user of the mobile application 108, the interface element with which the user is interacting, the user profile characteristics with respect to the experience level and the preference of the user, and the environment factor with respect to the time, the location, and the device that the user is using. The step 314 also involves selecting the adaptation strategy from the set of adaptation strategies, based on the obtained situational factors and the determined current emotional state of the current user.

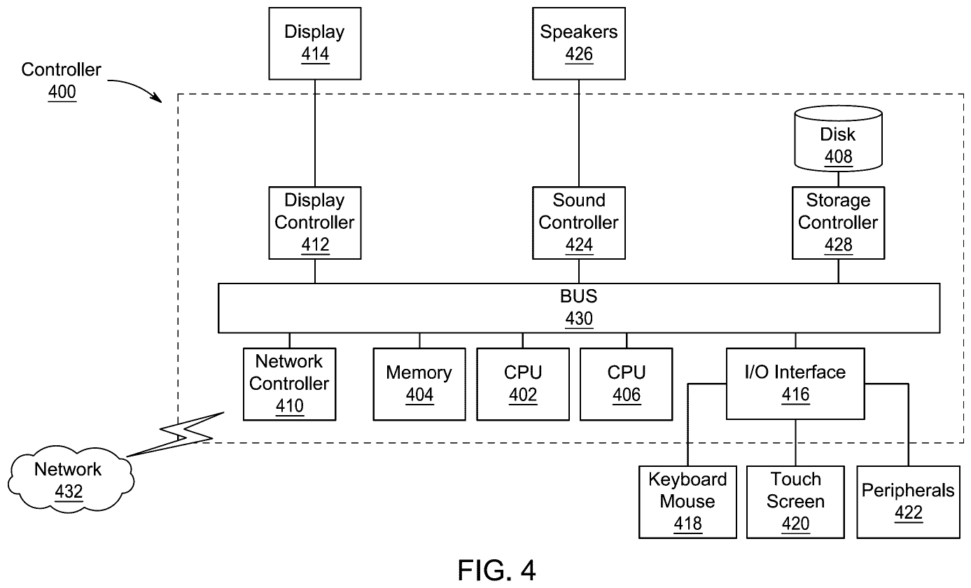

FIG. 4 is an illustration of a non-limiting example of details of a computing hardware used in a computing system, according to certain embodiments. In the FIG. 4, a controller 400 is described as representative of the computing system in which the controller 400 is a computing device which includes a central processing unit (CPU) 402 which performs processes described above/below. The process data and instructions may be stored in a memory 404. These processes and instructions may also be stored on a storage medium disk 408 such as a hard drive (HDD) or a portable storage medium or may be stored remotely.

Further, claims are not limited by the form of the computer-readable media on which the instructions of the inventive process are stored. For example, the instructions may be stored on compact discs (CDs), digital versatile disc (DVDs), in FLASH memory, read access memory (RAM), read only memory (ROM), programmable read only memory (PROM), erasable programmable read only memory (EPROM), electrically erasable programmable read only memory (EEPROM), hard disk or any other information processing device with which the computing device communicates, such as a server or computer.

Further, the claims may be provided as a utility application, background daemon, or component of an operating system, or combination thereof, executing in conjunction with CPU 402, 406 and an operating system such as Microsoft Windows 7, Microsoft Windows 10, UNiplexed Information Computing System (UNIX), Solaris, Lovable Intellect Not Using XP (LINUX), Apple Macintosh (MAC)-Operating System (OS) and other systems known to those skilled in the art.

The hardware elements in order to achieve the computing device may be realized by various circuitry elements, known to those skilled in the art. For example, CPU 402 or CPU 406 may be a Xenon or Core processor from Intel of America or an Opteron processor from advanced micro devices (AMD) of America, or may be other processor types that would be recognized by one of ordinary skill in the art. Alternatively, the CPU 402, 406 may be implemented on a field programmable Gate array (FPGA), application-specific integrated circuit (ASIC), programmable logic device (PLD) or using discrete logic circuits, as one of ordinary skill in the art would recognize. Further, CPU 402, 406 may be implemented as multiple processors cooperatively working in parallel to perform the instructions of the inventive processes described above.

The computing device in the FIG. 4 also includes a network controller 410, such as an Intel Ethernet PRO network interface card from Intel Corporation of America, for interfacing with network 432. As can be appreciated, the network 432 can be a public network, such as the Internet, or a private network such as a local area network (LAN) or a wide area network (WAN) network, or any combination thereof and can also include public switched telephone network, (PSTN) or an integrated services digital network (ISDN) sub-networks. The network 432 can also be wired, such as an Ethernet network, or can be wireless such as a cellular network including EDGE, 3G and 4G wireless cellular systems. The wireless network can also be Wireless Fidelity (WiFi), Bluetooth, or any other wireless form of communication that is known.

The computing device further includes a display controller 412, such as a NVIDIA GeForce GTX or Quadro graphics adaptor from NVIDIA Corporation of America for interfacing with display 414, such as a Hewlett Packard HPL2445w LCD monitor. A general purpose I/O interface 416 interfaces with a keyboard and/or mouse 418 as well as a touch screen panel 420 on or separate from display 414. General purpose I/O interface also connects to a variety of peripherals 422 including printers and scanners, such as an OfficeJet or DeskJet from Hewlett Packard.

A sound controller 424 is also provided in the computing device such as Sound Blaster X-Fi Titanium from Creative, to interface with speakers/microphone 426 thereby providing sounds and/or music.

The general purpose storage controller 428 connects the storage medium disk 408 with communication bus 430, which may be an instruction set architecture (ISA), extended industry standard architecture (EISA), video electronics standards association (VESA), peripheral component interconnect (PCI), or similar, for interconnecting all of the components of the computing device. A description of the general features and functionality of the display 414, keyboard and/or mouse 418, as well as the display controller 412, storage controller 428, network controller 410, sound controller 424, and general purpose I/O interface 416 is omitted herein for brevity as these features are known.

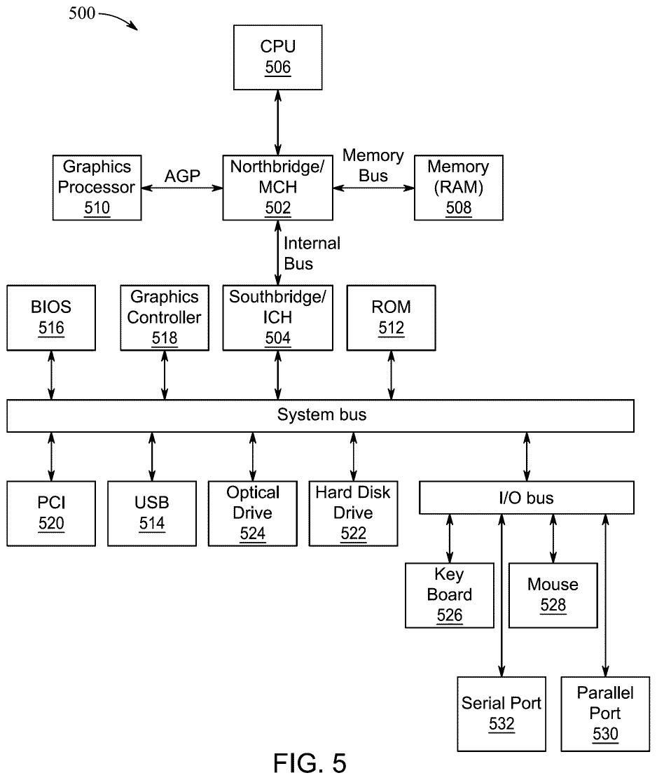

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 5.

FIG. 5 is an exemplary schematic diagram of a data processing system 500 used within the computing system, according to certain embodiments, for performing the functions of the exemplary embodiments. The data processing system 500 is an example of a computer in which code or instructions implementing the processes of the illustrative embodiments may be located.

In the FIG. 5, the data processing system 500 employs a hub architecture including a north bridge and memory controller hub (NB/MCH) 502 and a south bridge and input/output (I/O) controller hub (SB/ICH) 504. The central processing unit (CPU) 506 is connected to the NB/MCH 502. The NB/MCH 502 also connects to the memory 508 via a memory bus, and connects to the graphics processor 510 via an accelerated graphics port (AGP). The NB/MCH 502 also connects to the SB/ICH 504 via an internal bus (e.g., a unified media interface or a direct media interface). The CPU 506 may contain one or more processors and even may be implemented using one or more heterogeneous processor systems.

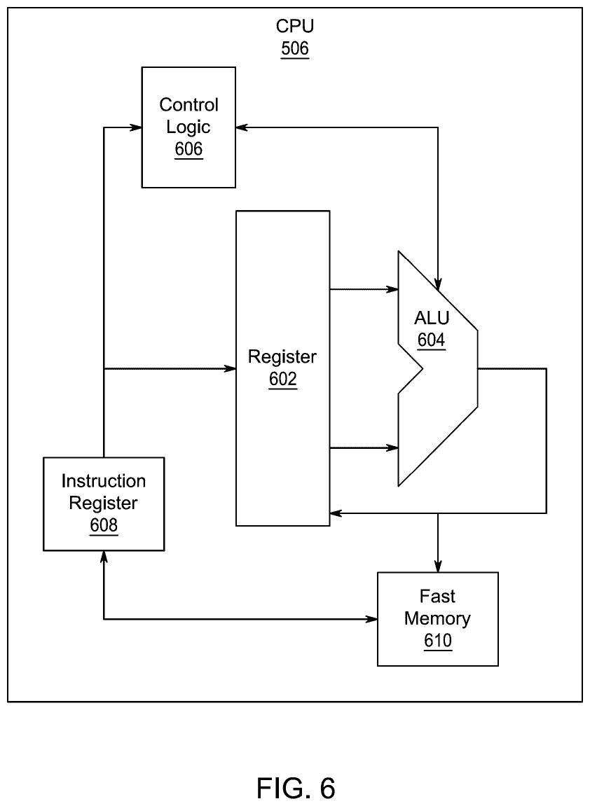

For example, FIG. 6 shows one implementation of the CPU 506. In one implementation, the instruction register 608 retrieves instructions from the fast memory 610. At least part of these instructions is fetched from the instruction register 608 by the control logic 606 and interpreted according to the instruction set architecture of the CPU 506. Part of the instructions can also be directed to the register 602. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 604 that loads values from the register 602 and performs logical and mathematical operations on the loaded values according to the instructions. The results from these operations can be feedback into the register 602 and/or stored in the fast memory 610. According to certain implementations, the instruction set architecture of the CPU 506 can use a reduced instruction set architecture, a complex instruction set architecture, a vector processor architecture, a very large instruction word architecture. Furthermore, the CPU 506 can be based on a Von Neuman model or a Harvard model. The CPU 506 can be a digital signal processor, the FPGA, the ASIC, the PLA, a PLD, or a CPLD. Further, the CPU 506 can be an x86 processor by Intel or by AMD; an ARM processor, a Power architecture processor by, e.g., IBM; a SPARC architecture processor by Sun Microsystems or by Oracle; or other known CPU architecture.

Referring again to the FIG. 5, the data processing system 500 can include that the SB/ICH 504 is coupled through a system bus to an I/O Bus, a read only memory (ROM) 512, universal serial bus (USB) port 514, a flash binary input/output system (BIOS) 516, and a graphics controller 518. PCI/PCIe devices can also be coupled to SB/ICH 504 through a PCI bus 520.

The PCI devices may include, for example, Ethernet adapters, add-in cards, and PC cards for notebook computers. The Hard disk drive 522 and CD-ROM 524 can use, for example, an integrated drive electronics (IDE) or serial advanced technology attachment (SATA) interface. In one implementation the I/O bus can include a super I/O (SIO) device.

Further, the hard disk drive (HDD) 522 and optical drive 524 can also be coupled to the SB/ICH 504 through a system bus. In one implementation, a keyboard 526, a mouse 528, a parallel port 530, and a serial port 532 can be connected to the system bus through the I/O bus. Other peripherals and devices that can be connected to the SB/ICH 504 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

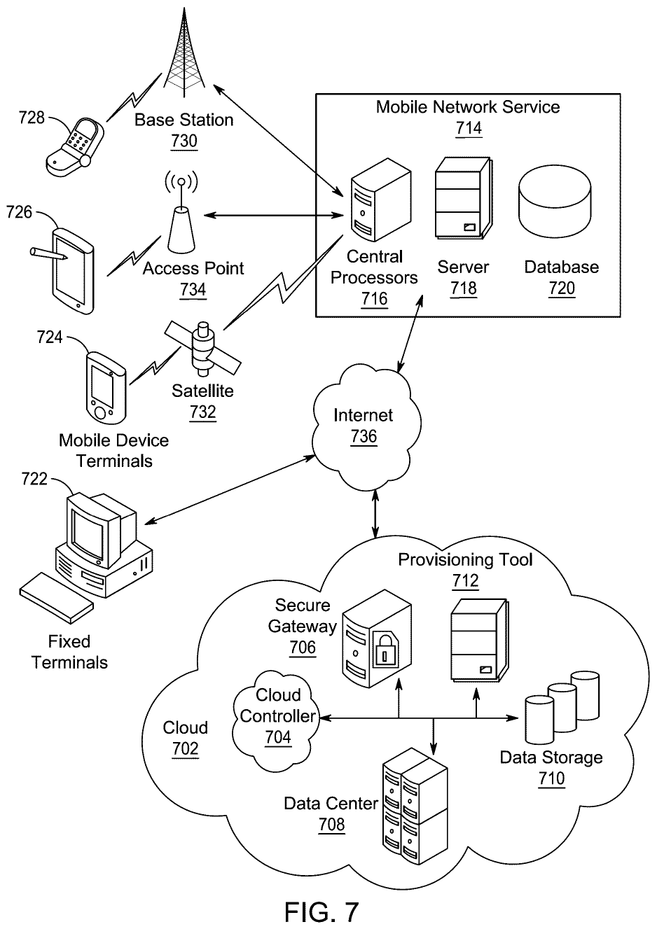

The functions and features described herein may also be executed by various distributed components of a system. For example, one or more processors may execute these system functions, wherein the processors are distributed across multiple components communicating in a network. The distributed components may include one or more client and server machines, such as cloud 702 including a cloud controller 704, a secure gateway 706, a data center 708, data storage 710 and a provisioning tool 712, and mobile network services 714 including central processors 716, a server 718 and a database 720, which may share processing, as shown by FIG. 7, in addition to various human interface and communication devices (e.g., display monitors 722, smart phones 724, tablets 726, personal digital assistants (PDAs) 728). The network may be a private network, such as a base station 730, satellite 732 or access point 734, or be a public network, may such as the Internet 736. Input to the system may be received via direct user input and received remotely either in real-time or as a batch process. Additionally, some implementations may be performed on modules or hardware that are not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A method for developing an emotion-aware adaptive user interface for a mobile application, comprising:
identifying a plurality of emotional requirements of users of the mobile application;
based on the plurality of emotional requirements, building an emotional goal model, the emotional goal model representing relationships between a plurality of emotional goals and a plurality of applications features of the mobile application;
constructing an emotion transition map that defines a number of user emotional states and transitions between the number of user emotional states;
based on the emotional goal model and the emotion transition map, designing a set of adaptation strategies for adapting applications features in response to user emotional states; and
incorporating the set of adaptation strategies into the mobile application, such that the mobile application is configured to:
based on a signal obtained from a current user of the mobile application, determine a current user emotional state, and
adjust an application feature in response to the determined current user emotional state, based on an adaptation strategy selected from the set of adaptation strategies.

2. The method of claim 1, wherein the identifying step further comprises:
collecting, from a plurality of users, qualitative and quantitative feedbacks on the mobile application,
using the collected feedbacks as inputs, inferring a plurality of discrete emotion labels via a first trained neural network, and
clustering, via a second trained neural network, the plurality of discrete emotion labels, to obtain the plurality of emotional requirements.

3. The method of claim 2, wherein the qualitative and quantitative feedbacks include a plurality of pleasure-arousal-dominance (PAD) ratings provided by the plurality of users, and
the first trained neural network includes a K-nearest neighbors classifier that is trained for associating a set of discrete emotion labels with a set of PAD ratings.

4. The method of claim 2, wherein the second trained neural network is based on a K-means clustering algorithm, and the K-means clustering algorithm is configured to conduct clustering by identifying patterns and relationships between the plurality of discrete emotion labels across the plurality of users.

5. The method of claim 1, wherein the building step further comprises:
representing the plurality of emotional requirements as a plurality of soft goals,
representing the plurality of applications features as a plurality of intentional elements,
assessing impacts of the plurality of intentional elements on the plurality of soft goals, and
modeling the assessed impacts as contribution links, so as to build the emotional goal model representing the relationships between the plurality of emotional goals and the plurality of applications features.

6. The method of claim 5, wherein the plurality of applications features include:
user interface elements including a color scheme, a layout, a font size, and an animation,
a content adaptation with respect to a presentation of text, images, and multimedia contents,
a functionality change with respect to complexity of interactions, a different level of assistance, and an alternative workflow, and
a feedback mechanism that varies a type and frequency of feedback provided to application users.

7. The method of claim 5, wherein the building step further comprises:
defining a first additional emotional goal and a second additional emotional goal, the first additional emotional goal representing a positive emotional state, the second additional emotional goal representing a negative emotional state, and
assessing impacts of the plurality of soft goals on the first and second additional emotional goals.

8. The method of claim 1, wherein the constructing step further comprises:
identifying a set of primary user emotional states having a higher probability than other user emotional states, as the number of user emotional states,
representing the set of user emotional states as a set of emotion nodes,
arranging the set of emotion nodes into a network to construct the emotion transition map, with branches of the network representing transitions between the set of primary user emotional states.

9. The method of claim 8, wherein the representing step further comprises mapping the set of user emotional states to a set of points within a three-dimensional (3D) pleasure-arousal-dominance (PAD) space.

10. The method of claim 9, wherein the arranging step further comprises applying a Kruskal's minimum spanning tree algorithm to connect the set of points within the 3D PAD space to form the network.

11. The method of claim 8, wherein the set of primary user emotional states include: satisfied, excited, joyful, interested, respectful, secure, relaxed, happy, responsible, surprised, anxious, contemptuous, annoyed, dissatisfied, fearful, frustrated, confused, disgusted, angry, sad, and bored.

12. The method of claim 1, wherein the designing step further comprises:
based on the emotional goal model and the emotion transition map, designing a plurality of adaptation strategies that promote a positive emotional state and mitigate a negative emotional state,
validating effectiveness of each of the plurality of adaptation strategies, and deriving a plurality of validated adaptation strategies, as the set of adaptation strategies.

13. The method of claim 12, wherein the designed plurality of adaptation strategies are encapsulated with a plurality of user case maps, each user case map representing a sequence of adaptation actions and system responses associated with a corresponding adaptation strategy.

14. The method of claim 1, where the mobile application is enabled to adjust the application feature by:
performing a context analysis to obtain a plurality of situational factors of the mobile application,
selecting an adaptation strategy from the set of adaptation strategies, based on the obtained plurality of situational factors and the determined current user emotional state, and
adjusting the application feature based on the selected adaptation strategy.

15. The method of claim 14, wherein the plurality of situational factors includes:
a current task of the current user of the mobile application,
an interface element with which the current user is interacting,
a user profile characteristic with respect to an experience level and a preference of the current user, and
an environment factor with respect to a time, a location, and a device that the current user is using.

16. The method of claim 1, wherein the mobile application is enabled to determine the current user emotional state by:
continuously obtaining a signal from the current user,
assessing, based on the obtained signal, a motional state of the current user in a real time manner, as the determined current user emotional state.

17. The method of claim 16, wherein the obtained signal is a physiological signal measured from the current user via a sensor, and
the physiological signal includes a signal with respect to a facial expression, a body posture, a voice tone, a speech pattern, a heart rate, a heart rate variability, a breathing rate, a breathing pattern, an eye movement, a blink rate, a body temperature, a skin color, and skin conductance of the current user.

18. The method of claim 16, wherein the obtained signal is a signal reported by the current user.

19. A system for developing an emotion-aware adaptive user interface for a mobile application, comprising:
processing circuitry configured to
identify a plurality of emotional requirements of users of the mobile application;
based on the plurality of emotional requirements, build an emotional goal model, the emotional goal model representing relationships between a plurality of emotional goals and a plurality of applications features;
construct an emotion transition map that defines a number of user emotional states and transitions between the number of user emotional states;
based on the emotional goal model and the emotion transition map, design a set of adaptation strategies for adapting applications features in response to user emotional states; and
incorporate the set of adaptation strategies into the mobile application, such that the mobile application is enabled to:
based on a signal obtained from a current user of the mobile application, determine a current user emotional state, and
adjust an application feature in response to the determined current user emotional state, based on an adaptation strategy selected from the set of adaptation strategies.

20. A non-transitory computer readable medium having instructions stored therein that, when executed by one or more processors, cause the one or more processors to perform a method for developing an emotion-aware adaptive user interface for a mobile application, the method comprising:
identifying a plurality of emotional requirements of users of the mobile application;
based on the plurality of emotional requirements, building an emotional goal model, the emotional goal model representing relationships between a plurality of emotional goals and a plurality of applications features;
constructing an emotion transition map that defines a number of user emotional states and transitions between the number of user emotional states;
based on the emotional goal model and the emotion transition map, designing a set of adaptation strategies for adapting applications features in response to user emotional states; and
incorporating the set of adaptation strategies into the mobile application, such that the mobile application is enabled to:
based on a signal obtained from a current user of the mobile application, determine a current user emotional state, and
adjust an application feature in response to the determined current user emotional state, based on an adaptation strategy selected from the set of adaptation strategies.
